(19) United States
(12) Patent Application Publication
(10) Pub. No.: US 2025/0337457 A1
(43) Pub. Date: Oct. 30, 2025

(54) BASE STATION HAVING VIRTUALIZED DISTRIBUTED ANTENNA SYSTEM FUNCTION

(71) Applicant: Outdoor Wireless Networks LLC, Claremont, NC (US)

(72) Inventors: Suresh N. Sriram, Bangalore (IN); Milind Kulkarni, Hawthorn Woods, IL (US); Thomas Kummetz, Bayern (DE)

(73) Assignee: Outdoor Wireless Networks LLC, Claremont, NC (US)

(21) Appl. No.: 18/867,952

(22) PCT Filed: May 19, 2023
(86) PCT No.: PCT/US2023/022993

§ 371 Date: Nov. 21, 2024

(30) Foreign Application Priority Data
May 21, 2022 (IN) 202241029310

(51) Int. Cl. H04B 7/022

(52) U.S. Cl. CPC H04B 7/022

(57) ABSTRACT

One embodiment is directed to a radio access network (RAN) that comprises a set of one or more physical server computers configured to execute virtualization software that creates a virtualized environment. The set of physical server computers is configured to instantiate and execute a set of one or more virtual network functions (VNFs) used to implement at least one native base station and a virtual master unit (vMU) of a virtual distributed antenna system (vDAS). The vDAS is configured to serve a foreign base station. The RAN further comprises a plurality of radio units (RUs), each of the RUs associated with a respective set of coverage antennas. At least some of the RUs of the RAN are also used to implement the vDAS for serving the foreign base station.

### CROSS-REFERENCE TO RELATED APPLICATIONS

This application claims the benefit of Indian Provisional Patent Application Serial No. 202241029310, filed on May 21, 2022, which is hereby incorporated herein by reference in its entirety.

### BACKGROUND

A distributed antenna system (DAS) typically includes one or more central units or nodes (also referred to here as “central access nodes (CANs)” or “master units”) that are communicatively coupled to a plurality of remotely located access points or antenna units (also referred to here as “remote antenna units” or “radio units”), where each access point can be coupled directly to one or more of the central access nodes or indirectly via one or more other remote units and/or via one or more intermediary or expansion units or nodes (also referred to here as “transport expansion nodes (TENs)”). A DAS is typically used to improve the coverage provided by one or more base stations that are coupled to the central access nodes. These base stations can be coupled to the one or more central access nodes via one or more cables or via a wireless connection, for example, using one or more donor antennas. The wireless service provided by the base stations can include commercial cellular service and/or private or public safety wireless communications.

In general, each central access node receives one or more downlink signals from one or more base stations and generates one or more downlink transport signals derived from one or more of the received downlink base station signals. Each central access node transmits one or more downlink transport signals to one or more of the access points. Each access point receives the downlink transport signals transmitted to it from one or more central access nodes and uses the received downlink transport signals to generate one or more downlink radio frequency signals that are radiated from one or more coverage antennas associated with that access point. The downlink radio frequency signals are radiated for reception by user equipment. Typically, the downlink radio frequency signals associated with each base station are simulcasted from multiple remote units. In this way, the DAS increases the coverage area for the downlink capacity provided by the base stations.

Likewise, each access point receives one or more uplink radio frequency signals transmitted from the user equipment. Each access point generates one or more uplink transport signals derived from the one or more uplink radio frequency signals and transmits them to one or more of the central access nodes. Each central access node receives the respective uplink transport signals transmitted to it from one or more access points and uses the received uplink transport signals to generate one or more uplink base station radio frequency signals that are provided to the one or more base stations associated with that central access node. Typically, this involves, among other things, combining or summing uplink signals received from multiple access points in order to produce the base station signal provided to each base station. In this way, the DAS increases the coverage area for the uplink capacity provided by the base stations.

A DAS can use either digital transport, analog transport, or combinations of digital and analog transport for generating and communicating the transport signals between the central access nodes, the access points, and any transport expansion nodes.

Custom, physical hardware is typically used to implement the various nodes of a DAS. Also, the various nodes of a DAS are typically coupled to each other using dedicated point-to-point communication links. While these dedicated point-to-point links may be implemented using Ethernet physical layer (PHY) technology (for example, by using Gigabit Ethernet PHY devices and cabling), conventional “shared” switched Ethernet networks are typically not used for communicating among the various nodes of a DAS.

As a result, a traditional DAS is typically expensive to deploy—both in terms of product and installation costs. Moreover, the scalability and upgradeability of a traditional DAS is typically limited, time-consuming, and involves adding or changing hardware and/or communication links.

Also, the resources (for example, hardware and transport communication links) used in implementing a base station have traditionally been separate from the resources used for implementing a DAS. As a result, adding a DAS to an existing base station deployment typically involves significant incremental costs related to providing the separate resources for implementing the DAS.

### SUMMARY

One embodiment is directed to a radio access network (RAN) comprising a set of one or more physical server computers configured to execute virtualization software that creates a virtualized environment. The set of physical server computers is configured to instantiate and execute a set of one or more virtual network functions (VNFs) used to implement at least one native base station and a virtual master unit (vMU) of a virtual distributed antenna system (vDAS). The vDAS is configured to serve a foreign base station. The RAN further comprises a plurality of radio units (RUs). Each of the RUs is associated with a respective set of coverage antennas. The set of physical server computers is communicatively coupled to the plurality of RUs using a fronthaul network. The vDAS is configured to receive a set of downlink base station signals from a foreign base station and generate downlink base station data from the set of downlink base station signals. The vMU is configured to generate downlink transport data derived from the downlink base station data and communicate the downlink transport data to one or more of the RUs. Each of said one or more of the RUs is configured to receive the downlink transport data, generate a set of downlink analog radio frequency (RF) signals from the downlink transport data, and wirelessly transmit the set of downlink analog RF signals from the respective set of coverage antennas associated with that RU. Each of said one or more of the RUs is configured to receive a respective set of uplink analog RF signals via the respective set of coverage antennas associated with that RU, generate respective uplink transport data from the respective set of uplink analog RF signals, and communicate the uplink transport data over the fronthaul network. The vMU is configured to receive uplink transport data derived from the uplink transport communicated over the fronthaul network by each of said one or more of the RUs and generate uplink base station data from the uplink transport data received by the vMU. The vDAS is configured to generate a set of uplink base station signals from the uplink base station data and provide the set of uplink base station signals to the foreign base station.

Another embodiment is directed to a method of providing wireless communication using a radio access network (RAN) comprising a set of one or more physical server computers configured to execute virtualization software that creates a virtualized environment. The set of physical server computers is configured to instantiate and execute a set of one or more virtual network functions (VNFs) used to implement at least one native base station and a virtual master unit (vMU) of a virtual distributed antenna system (vDAS). The vDAS is configured to serve a foreign base station. The RAN further comprises a plurality of radio units (RUs). Each of the RUs is associated with a respective set of coverage antennas. The set of physical server computers is communicatively coupled to the plurality of RUs using a fronthaul network. The method comprises: receiving a set of downlink base station signals from the foreign base station; generating downlink base station data from the set of downlink base station signals; generating, by the vMU, downlink transport data derived from the downlink base station data; communicating, by the vMU, the downlink transport data to one or more of the RUs; receiving, by each of the one or more RUs, the downlink transport data; generating a respective set of downlink analog radio frequency (RF) signals from the downlink transport data; wirelessly transmitting the respective set of downlink analog RF signals from the respective set of coverage antennas associated with that RU; wirelessly receiving, by each of said one or more of the RUs, a respective set of uplink analog RF signals via the respective set of coverage antennas associated with that RU; generating, by each of said one or more of the RUs, respective uplink transport data from the respective set of uplink analog RF signals received by that RU; communicating, by each of said one or more of the RUs, the respective uplink transport data over the fronthaul network; receiving, by the vMU, uplink transport data derived from the respective uplink transport data communicated from each of said one or more of the RUs; generating, by the vMU, uplink base station data from the uplink transport data received from all of said one or more of the RUs; generating a set of uplink base station signals from the uplink base station data; and providing the set of uplink base station signals to the foreign base station.

Other embodiments are disclosed.

The details of various embodiments are set forth in the accompanying drawings and the description below. Other features and advantages will become apparent from the description, the drawings, and the claims.

### BRIEF DESCRIPTION OF DRAWINGS

FIG. 1 is a block diagram illustrating one exemplary embodiment of a radio access network (RAN) system in which a virtual distributed antenna system (vDAS) is implemented.

FIG. 2 is a block diagram illustrating one exemplary embodiment of a radio unit (RU) that can be used in the vDAS of FIG. 1.

FIG. 3 comprises a high-level flowchart illustrating one exemplary embodiment of a method of providing wireless communication in a downlink direction using a foreign base station coupled to a virtual distributed antenna system.

FIG. 4 comprises a high-level flowchart illustrating one exemplary embodiment of a method of providing wireless communication in an uplink direction using a foreign base station coupled to a virtual distributed antenna system.

FIG. 5 is a block diagram illustrating another exemplary embodiment of a RAN system in which a vDAS is implemented.

FIG. 6 is a block diagram illustrating another exemplary embodiment of a RAN system in which a vDAS is implemented using at least one by-pass physical RF donor.

FIG. 7 is a block diagram illustrating another exemplary embodiment of a RAN system in which a vDAS is implemented.

Like reference numbers and designations in the various drawings indicate like elements.

### DETAILED DESCRIPTION

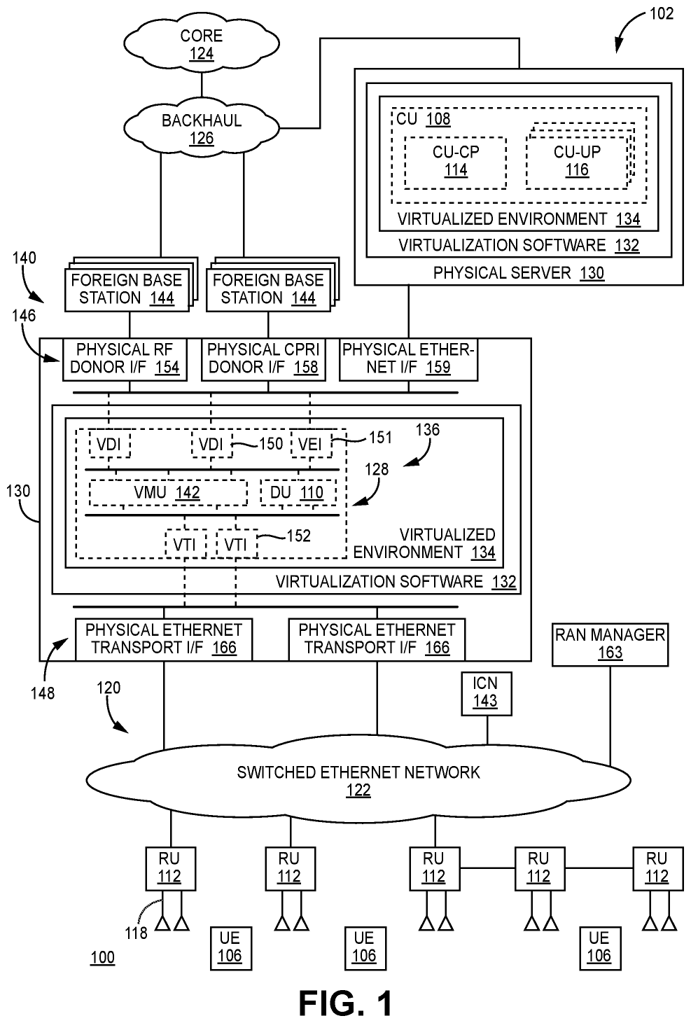

FIG. 1 is a block diagram illustrating one exemplary embodiment of a radio access network (RAN) system 100 in which the techniques for implementing a distributed antenna system described below can be used.

The system 100 shown in FIG. 1 implements at least one base station entity 102 to serve a cell. Each such base station entity 102 can also be referred to here as a “base station” or “base station system” (and, which in the context of a fourth generation (4G) Long Term Evolution (LTE) system, may also be referred to as an “evolved NodeB”, “eNodeB”, or “eNB” and, in the context of a fifth generation (5G) New Radio (NR) system, may also be referred to as a “gNodeB” or “gNB”).

In general, each base station 102 is configured to provide wireless service to various items of user equipment (UEs) 106 served by the associated cell. Unless explicitly stated to the contrary, references to Layer 1, Layer 2, Layer 3, and other or equivalent layers (such as the Physical Layer or the Media Access Control (MAC) Layer) refer to layers of the particular wireless interface (for example, 4G LTE or 5G NR) used for wirelessly communicating with UEs 106. Furthermore, it is also to be understood that 5G NR embodiments can be used in both standalone and non-standalone modes (or other modes developed in the future) and the following description is not intended to be limited to any particular mode. Moreover, although some embodiments are described here as being implemented for use with 5G NR, other embodiments can be implemented for use with other wireless interfaces and the following description is not intended to be limited to any particular wireless interface.

In the specific exemplary embodiment shown in FIG. 1, each base station 102 is implemented as a respective 5G NR gNB 102 (only one of which is shown in FIG. 1 for ease of illustration). In this embodiment, each gNB 102 is partitioned into one or more central unit entities (CUs) 108, one or more distributed unit entities (DUs) 110, and one or more radio units (RUs) 112. In such a configuration, each CU 108 implements Layer 3 and non-time critical Layer 2 functions for the gNB 102. In the embodiment shown in FIG. 1, each CU 108 is further partitioned into one or more control-plane entities 114 and one or more user-plane entities 116 that handle the control-plane and user-plane processing of the CU 108, respectively. Each such control-plane CU entity 114 is also referred to as a “CU-CP” 114, and each such user-plane CU entity 116 is also referred to as a “CU-UP” 116. Also, in such a configuration, each DU 110 is configured to implement the time critical Layer 2 functions and, except as described below, at least some of the Layer 1 functions for the gNB 102. In this example, each RU 112 is configured to implement the physical layer functions for the gNB 102 that are not implemented in the DU 110 as well as the RF interface. Also, each RU 112 includes a respective set of antennas 118 via which downlink analog RF signals can be radiated to UEs 106 and via which uplink analog RF signals transmitted by UEs 106 can be received. Although only two antennas 118 are shown in FIG. 1 for ease of illustration, it is to be understood that other numbers of antennas 118 can be used.

Each RU 112 is communicatively coupled to the DU 110 serving it via a fronthaul network 120. More specifically, in the example shown in FIG. 1, the fronthaul network 120 is implemented using at least one switched Ethernet network 122 and each RU 112 and each physical node on which each DU 110 is implemented includes one or more Ethernet network interfaces to couple each RU 112 and each DU physical node to the switched Ethernet network 122 in order to facilitate communications between the DU 110 and the RUs 112. In one implementation, the fronthaul interface promulgated by the O-RAN Alliance is used for communication between the DU 110 and the RUs 112 over the fronthaul network 120. In another implementation, a proprietary fronthaul interface that uses a so-called “functional split 7-2” for at least some of the physical channels (for example, for the PDSCH and PUSCH) and a different functional split for at last some of the other physical channels (for example, using a functional split 6 for the PRACH and SRS). Other fronthaul interfaces (including, for example, a Common Public Radio Interface (CPRI) interface, an evolved CPRI (eCPRI) interface, an IEEE 1914.3 Radio-over-Ethernet (RoE) interface, a functional application programming interface (FAPI) interface, a network FAPI (nFAPI) interface) and/or functional splits can be used (including, for example, functional split 8, functional split 7-2, and functional split 6).

In such an example, each CU 108 is configured to communicate with a core network 124 of the associated wireless operator using an appropriate backhaul network 126 (typically, a public wide area network such as the Internet).

In the exemplary embodiment shown in FIG. 1, the RAN 100 can also include a RAN manager 163 that is configured to implement various management-plane functions including, for example, service orchestration, commissioning, configuration, alarm management, and quotas for the base stations 102 and/or the vDAS 140 (described below) and/or the hardware or other resources used to implement the RAN 100 (including, for example, the physical servers 130, the network 122, and/or virtualization software 132 and/or any entities or environments implemented using the virtualization software 132).

Although FIG. 1 (and the description set forth below more generally) is described in the context of a 5G embodiment in which each logical base station entity 102 is partitioned into a CU 108, DUs 110, and RUs 112 and, for at least some of the physical channels, some physical-layer processing is performed in the DUs 110 with the remaining physical-layer processing being performed in the RUs 112, it is to be understood that the techniques described here can be used with other wireless interfaces (for example, 4G LTE) and with other ways of implementing a base station entity (for example, using a conventional baseband band unit (BBU)/remote radio head (RRH) architecture). Accordingly, references to a CU, DU, or RU in this description and associated figures can also be considered to refer more generally to any entity (including, for example, any “base station” or “RAN” entity) implementing any of the functions or features described here as being implemented by a CU, DU, or RU.

Each CU 108, DU 110, RU 112, and RAN manager 163 and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.).

Moreover, each CU 108, DU 110, RU 112, and RAN manager 163 can be implemented as a physical network function (PNF) (for example, using dedicated physical programmable devices and other circuitry) and/or a virtual network function (VNF) (for example, using one or more general purpose servers (possibly with hardware acceleration) in a scalable cloud environment and in different locations within an operator's network (for example, in the operator's “edge cloud” or “central cloud”). Each VNF can be implemented using hardware virtualization, operating system virtualization (also referred to as containerization), and application virtualization as well as various combinations of two or more the preceding. Where containerization is used to implement a VNF, it may also be referred to as a “containerized network function” (CNF).

For example, in the exemplary embodiment shown in FIG. 1, each RU 112 is implemented as a PNF and is deployed in or near a physical location where radio coverage is to be provided and each CU 108 and DU 110 is implemented using a respective set of one or more VNFs deployed in a distributed manner within one or more clouds (for example, within an “edge” cloud or “central” cloud). More specifically, in the exemplary embodiment shown in FIG. 1, each CU 108 and DU 110 is implemented using a set of one or more virtual network functions (VNFs) 128 executing on a set of one or more physical server computers (also referred to here as “physical servers” or just “servers”) 130 (for example, one or more commercial-off-the-shelf (COTS) servers of the type that are deployed in data centers or “clouds” maintained by enterprises, communication service providers, or cloud services providers). Also, the RAN manager 163 can be implemented as VNF executing on a set of one or more physical server computers (not shown for ease of illustration).

Each such physical server computer 130 is configured to execute software that is configured to implement the various functions and features described here as being implemented by the associated VNF 128. Each such physical server computer 130 comprises one or more programmable processors for executing such software. The software comprises program instructions that are stored (or otherwise embodied) on or in an appropriate non-transitory storage medium or media (such as flash or other non-volatile memory, magnetic disc drives, and/or optical disc drives) from which at least a portion of the program instructions are read by the respective programmable processor for execution thereby. Both local storage media and remote storage media (for example, storage media that is accessible over a network), as well as removable media, can be used. Each such physical server computer 130 also includes memory for storing the program instructions (and any related data) during execution by the respective programmable processor.

In the example shown in FIG. 1, virtualization software 132 is executed on each physical server computer 130 in order to provide a virtualized environment 134 in which one or more one or more virtual entities 136 (such as one or more virtual machines and/or containers) are used to deploy and execute the one or more VNFs 130. In the following description, it should be understood that references to “virtualization” are intended to refer to, and include within their scope, any type of virtualization technology, including “container” based virtualization technology (such as, but not limited to, Kubernetes).

Each CU 108, DU 110, RU 112, and RAN manager 163 and any of the specific features described here as being implemented thereby, can be implemented in other ways.

In the exemplary embodiment shown in FIG. 1, the RAN 100 is configured so that the resources used to implement one or more base station entities 102 can also be used to implement a distributed antenna system (DAS). More specifically, in this embodiment, the resources used to implement one or more base station entities 102 are also used to implement a virtualized DAS (vDAS) 140 in which one or more nodes or functions of a traditional DAS (such as a master unit) are implemented using one or more VNFs 128 executing on one or more physical server computers 130.

More specifically, in the example shown in FIG. 1, the vDAS 140 comprises at least one virtualized master unit (vMU) 142. Each vMU 142 is configured to implement at least some of the functions normally carried out by a physical master unit or CAN in a traditional DAS. Also, in the example shown in FIG. 1, the vDAS 140 uses one or more of the RUs 112 of the RAN 100 as remote antenna units of the vDAS 140. That is, in this embodiment, the vDAS 140 uses RUs 112 that can also be used to implement one or more base station entities 102. In this exemplary embodiment, each RU 112 is a “multi-carrier” RU that is configured to implement multiple logical (or virtual) RU entities using the (physical) RU 112.

Each of the vMU 142 is implemented as a respective VNF 128 deployed on one or more of the physical servers 128. Each RU 112 used to implement the vDAS 140 is implemented as a physical network function (PNF) and is deployed in or near a physical location where coverage is to be provided. Each RU 112 used to implement the vDAS 140 is also referred to here as a “vDAS RU” 112. The switched Ethernet network 122 used to implement the fronthaul network 120 of the RAN 100 is also used to communicatively couple each vDAS RU 112 to one or more vMUs 142 of the vDAS 140. That is, in contrast to a traditional DAS in which each AP is coupled to each CAN serving it using only point-to-point links, in the vDAS 140 shown in FIG. 1, each vDAS RU 112 is coupled to each vMU 142 serving it using at least some shared communication links—where these “shared” communication links are shared among different vDAS RUs 112 and shared between the base station entities 102 and the vDAS 140. Optionally, some of the vDAS RUs 112 can be configured in a daisy-chain configuration in which one or more vDAS RUs 112 are subtended from another vDAS RU 112 (for example, using a respective southbound Ethernet interface (not shown)). In such a daisy chain configuration, each RU 112 that has a vDAS RU 112 subtended from it forwards downlink transport data intended for any subtended vDAS RU 112 to that subtended vDAS RU 112 via the southbound Ethernet interface and forwards uplink downlink transport received from any subtended vDAS RU 112 on its northbound Ethernet interface used to couple that vDAS RU 112 to a vMU 142 or another vDAS RU 112 in the daisy chain. Such a vDAS RU 112 can, optionally, perform combining or summing of uplink user-plane data.

The vDAS 140 is configured to be coupled to one or more base stations 102 or 144 in order to improve the coverage provided by the base stations 102 or 144. That is, each base station 102 or 144 is configured to provide wireless capacity, whereas the vDAS 140 is configured to provide improved wireless coverage for the wireless capacity provided by the base station 102 or 144. As used here, the base stations 102 that are implemented using the same resources as the vDAS 140 are referred to here as “native” base stations 102, and the base stations 144 are not implemented using the same resources as the vDAS 140 and the native base stations 102 are referred to here as “foreign” or “non-native” base stations 144.

As used here, unless otherwise explicitly indicated, references to a “foreign base station” 144 include both (1) a “complete” base station that interfaces with the vDAS 140 using the analog radio frequency (RF) interface that would otherwise be used to couple the complete base station to a set of antennas as well as (2) a first portion of a base station such as a baseband unit (BBU), distributed unit (DU), or similar base station entity) that interfaces with the vDAS 140 using a digital fronthaul interface that would otherwise be used to couple that first portion of the base station to a second portion of the base station (such as a remote radio head (RRH), radio unit (RU), or similar radio entity). In the latter case, different digital fronthaul interfaces can be used (including, for example, a Common Public Radio Interface (CPRI) interface, an evolved CPRI (eCPRI) interface, an IEEE 1914.3 Radio-over-Ethernet (RoE) interface, a functional application programming interface (FAPI) interface, a network FAPI (nFAPI) interface), or an Open-RAN (O-RAN) fronthaul interface) and different functional splits can be supported (including, for example, functional split 8, functional split 7-2, and functional split 6). The O-RAN Alliance publishes various specifications for implementing RANs in an open manner. (“O-RAN” is an acronym that also stands for “Open RAN,” but in this description references to “O-RAN” should be understood to be referring to the O-RAN Alliance and/or entities or interfaces implemented in accordance with one or more specifications published by the O-RAN Alliance.)

Each foreign base station 144 coupled to the vDAS 140 can be co-located with the vMU 142 to which it is coupled. A co-located foreign base station 144 can be coupled to the vMU 142 to which it is coupled using one or more point-to-point links (for example, where the foreign base station 144 is coupled to the vDAS 140 using an analog RF interface, one or more coaxial cables can be used and where the co-located base station 144 comprises a 4G LTE BBU supporting a CPRI fronthaul interface, one or more optical fibers can be used). Each foreign base station 144 coupled to the vDAS 140 can also be located remotely from the vMU 142 to which it is coupled. A remote foreign base station 144 can be coupled to the vMU 142 to which it is coupled via a wireless connection (for example, by using a donor antenna to wirelessly couple the remote foreign base station 144 to the vMU 142 using an analog RF interface) or via a wired connection (for example, by using one or more optical fibers to couple a 4G LTE BBU to the vMU 142 using a CPRI fronthaul interface).

The foreign base stations 144 can be coupled to the vDAS 140 in other ways. For example, the foreign base stations 144 can be coupled to the vDAS 140 using a network of attenuators, combiners, splitters, amplifiers, filters, cross-connects, etc., (sometimes referred to collectively as a “point-of-interface” or “POI”). This can be done so that, in the downlink, the desired set of sectors output by the foreign base stations 144 can be extracted, combined, and/or routed to the appropriate physical donor interface of the vDAS 140, and so that, in the upstream, the desired set of sectors output from the appropriate physical donor interface of the vDAS 140 can be extracted, combined, and/or routed to the appropriate interface of each foreign base station 144. It is to be understood, however, that this is one example and that other embodiments can be implemented in other ways.

The vDAS 140 described here is especially well-suited for use in deployments in which base stations from multiple wireless service operators desire to provide wireless service using the same set of RUs 112 (including, for example, neutral host deployments or deployments where one wireless service operator owns the vDAS 100 and provides other wireless service operators with access to its vDAS 100). For example, a first “host” wireless service provider can use the vDAS 140 in order to enable a second “client” wireless service provider to use the set of RUs 112 to serve a set of foreign base stations 144. By using the analog RF interface to couple the foreign base stations 144 to the vDAS 140, the client wireless service provider does not need to deploy the base station entities used to implement the foreign base stations 144 within the host service provider's RAN infrastructure, while still gaining access to the RUs 112 and the fronthaul network 120.

The vDAS 140 is also well-suited for use in deployments in which the wireless coverage of legacy base stations (for example, 4G LTE base stations) is improving using the same set of RUs 112 used to implement current generation base station entities (for example, 5G NR base stations), where the legacy base stations do not natively support using the RUs 112 used to implement the current generation base station entities.

The vDAS 140 described here is especially well-suited for use in such deployments because vMUs 142 can be easily instantiated in order to support additional wireless service operators and/or legacy base stations. This is the case even if an additional physical server computer 130 is needed in order to instantiate a new vMU 142 because such physical server computers 130 are either already available in such deployments or can be easily added at a low cost (for example, because of the COTS nature of such hardware). Other vDAS entities implemented in virtualized manner (for example, ICNs) can also be easily instantiated or removed as needed based on demand.

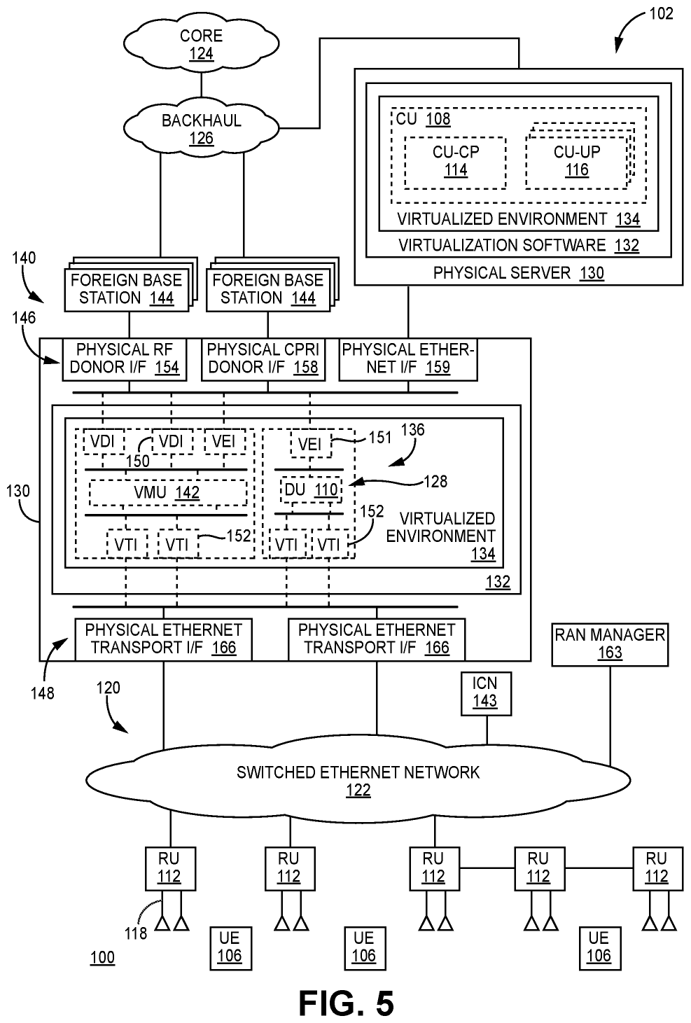

Moreover, the vDAS 140 can also be used to improve the coverage area of one or more native base stations 102 as well. Such native base stations 102 can be coupled to the vDAS 140 in various ways. For example, a native base station 102 can be coupled to a vMU 142 of the vDAS 140 using a physical Ethernet interface 159 (for example, where the vMU 142 is coupled to a DU 110 running a different physical server 130), via an interface provided in the virtual entity 136 (for example, as shown in FIG. 1 where the vMU 142 and DU 110 are implemented in the same virtual entity 130 (for example, in the same container or pod)) or via an interface provided in the virtualized environment 134 (for example, as shown in FIG. 5, where the vMU 142 and DU 110 are implemented in the same virtualized environment 134 using different virtual entities 130 (for example, in different containers or pods)).

More generally, the vDAS 140 described here can be used to serve base stations from multiple different wireless service operators, base stations implementing multiple different radio access technologies, base stations using multiple different RF bands or bandwidths, and/or base stations implemented using different technology. The vDAS 140 can be used with such different base stations to provide wireless service using the same set of RUs 112 (though, as noted below, a different configurable simulcast zone can be used with each such base station).

In the example shown in FIG. 1, the physical server computer 130 on which each vMU 142 is deployed includes one or more physical donor interfaces 146 that are each configured to communicatively couple the vMU 142 (and the physical server computer 130 on which it is deployed) to one or more foreign base stations 144. Also, the physical server computer 130 on which each vMU 142 is deployed includes one or more physical transport interfaces 148 that are each configured to communicatively couple the vMU 142 (and the physical server computer 130 on which it is deployed) to the fronthaul network 120 (and ultimately the RUs 112 and ICNs). Each physical donor interface 146 and physical transport interface 148 is a physical network function (PNF) (for example, implemented as a Peripheral Computer Interconnect Express (PCIe) device) deployed in or with the physical server computer 130.

In the example shown in FIG. 1, each physical server computer 130 on which each vMU 142 is deployed includes or is in communication with separate physical donor and transport interfaces 146 and 148; however, it is to be understood that in other embodiments a single set of physical interfaces 146 and 148 can be used for both donor purposes (that is, communication between the vMU 142 to one or more foreign base stations 144) and for transport purposes (that is, communication between the vMU 142 and the RUs 112 over the fronthaul network 120).

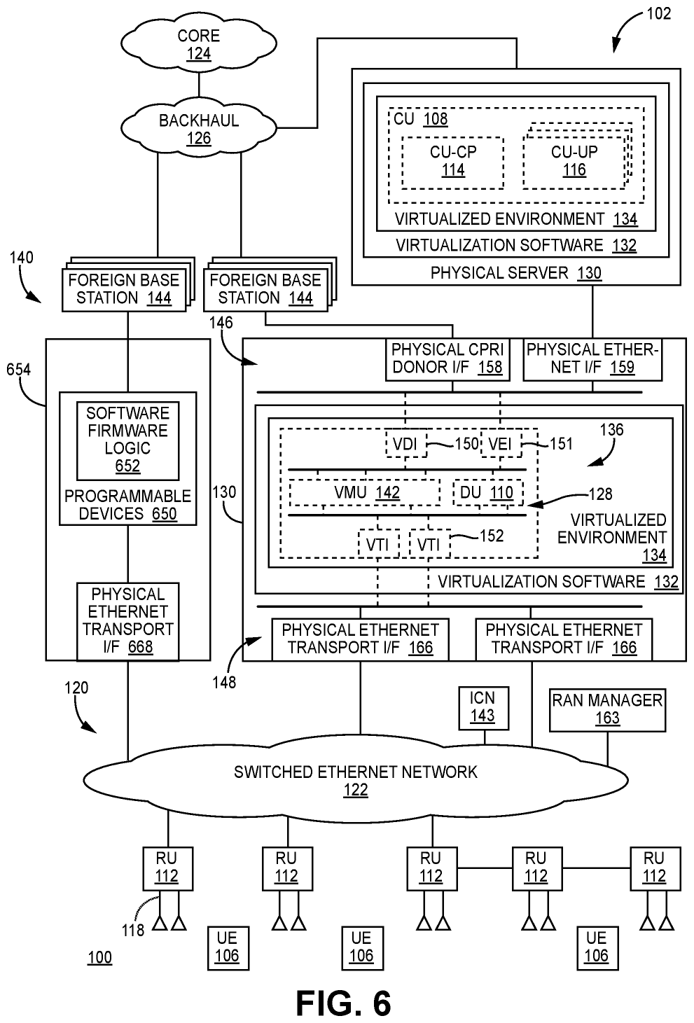

In the exemplary embodiment shown in FIG. 1, the physical donor interfaces 126 comprise one or more physical RF donor interfaces (also referred to here as “physical RF donor cards”) 154. Each physical RF donor interface 154 is in communication with one or more vMUs 142 executing on the physical server computer 130 in which that physical RF donor interface 154 is deployed (for example, by implementing the physical RF donor interface 154 as a card inserted in the physical server computer 130 and communicating over a PCIe lane with a central processing unit (CPU) used to execute each such vMU 142). Each physical RF donor interface 154 includes one or more sets of physical RF ports (not shown) to couple the physical RF donor interface 154 to one or more foreign base stations 144 using an analog RF interface. Each physical RF donor interface 154 is configured, for each foreign base station 144 coupled to it, to receive downlink analog RF signals from the foreign base station 144 via respective RF ports, convert the received downlink analog RF signals to digital downlink time-domain user-plane data, and output it to a vMU 142 executing on the same server computer 130 in which that RF donor interface 154 is deployed. Also, each physical RF donor interface 154 is configured, for each foreign base station 144 coupled to it, to receive digital combined uplink time-domain user-plane data from the vMU 142 for that base station 144, convert the received combined uplink time-domain user-plane data to uplink analog RF signals, and output them to the foreign base station 144. Moreover, the digital downlink time-domain user-plane data produced, and the digital uplink time-domain user-plane data received, by each physical RF donor interface 154 can be in the form of real digital values or complex (that is, in-phase and quadrature (IQ)) digital values and at baseband (that is, centered around 0 Hertz) or with a frequency offset near baseband or an intermediate frequency (IF). Alternatively, as described in more detail below in connection with FIG. 6, one or more of the physical RF donor interfaces can be configured to by-pass the vMU 142 and instead, for the base stations 144 coupled to that physical RF donor interface, have that physical RF donor interface perform some of the functions described here as being performed by the vMU 142 (including the digital combining or summing of user-plane data).

In the exemplary embodiment shown in FIG. 1, the physical donor interfaces 146 also comprise one or more physical CPRI donor interfaces (also referred to here as “physical CPRI donor cards”) 158. Each physical CPRI donor interface 158 is in communication with one or more vMUs 142 executing on the physical server computer 130 in which that physical CPRI donor interface 158 is deployed (for example, by implementing the physical CPRI donor interface 158 as a card inserted in the physical server computer 130 and communicating over a PCIe lane with a CPU used to execute each such vMU 142). Each physical CPRI donor interface 158 includes one or more sets of physical CPRI ports (not shown) to couple the physical CPRI donor interface 158 to one or more foreign base stations 144 using a CPRI interface. More specifically, in this example, each foreign base station 144 coupled to the physical CPRI donor interface 158 comprises a BBU or DU that is configured to communicate with a corresponding RRH or RU using a CPRI fronthaul interface. Each physical CPRI donor interface 158 is configured, for each foreign base station 144 coupled to it, to receive from the foreign base station 144 via a CPRI port digital downlink baseband data formatted for the CPRI fronthaul interface, extract the digital downlink baseband data, and output it to a vMU 142 executing on the same server computer 130 in which that CPRI donor interface 158 is deployed. Also, each physical CPRI donor interface 158 is configured, for each foreign base station 144 coupled to it, to receive digital uplink data including combined user-plane data from the vMU 142, format it for the CPRI fronthaul interface, and output the CPRI formatted data to the base station 144 via the CPRI ports.

As noted below, the vMU 142 and/or the physical donor interface can be configured to convert time-domain user-plane data exchanged with any foreign base station 144 to and from frequency-domain user-plane data in order to be compatible with the functional split used for the fronthaul interface used for communicating between the DU 110 and the RUs 112 of the native base stations 102 and/or in order to reduce the amount fronthaul bandwidth used for such data.

In the exemplary embodiment shown in FIG. 1, the physical transport interfaces 148 comprise one or more physical Ethernet transport interfaces 166. Each physical transport Ethernet interface 166 is in communication with one or more vMUs 142 executing on the physical server computer 130 in which that physical transport Ethernet interface 166 is deployed (for example, by implementing the physical transport Ethernet interface 166 as a card or module inserted in the physical server computer 130 and communicating over a PCIe lane with a CPU used to execute each such vMU 142). Each physical transport Ethernet interface 166 includes one or more sets of Ethernet ports (not shown) to couple the physical transport Ethernet interface 166 to the Ethernet cabling used to implement the fronthaul network 120 so that each vMU 142 can communicate with the various vDAS RUs 112 and ICNs. In some implementations, each physical transport Ethernet interface 166 is implemented using standard Ethernet interfaces of the type typically used with COTS physical servers.

In this exemplary embodiment, the virtualization software 132 is configured to implement within the virtual environment 134 a respective virtual interface for each of the physical donor interfaces 146 physical transport Ethernet interfaces 166, and other physical Ethernet interfaces 159 in order to provide and control access to the associated physical interface by each vMU 142 implemented within that virtual environment 134. That is, the virtualization software 132 is configured so that the virtual entity 136 used to implement each vMU 142 includes or communicates with a virtual donor interface (VDI) 150 that virtualizes and controls access to the underlying physical donor interface 146. Each VDI 150 can also be configured to perform some donor-related signal or other processing (for example, each VDI 150 can be configured to process the user-plane and/or control-plane data provided by the associated physical donor interface 146 in order to determine timing and system information for the base station and associated cell). Also, although each VDI 150 is illustrated in the examples shown here as being separate from the respective vMU 142 with which it is associated, it is to be understood that that each VDI 150 can also be implemented as a part of the vMU 142 with which it is associated.

Likewise, the virtualization software 132 is configured so that the virtual entity 136 used to implement each vMU 142 includes or communicates with a virtual transport interface (VTI) 152 that virtualizes and controls access to the underlying physical transport interface 148. Each VTI 152 can also be configured to perform some transport-related signal or other processing. Also, although each VTI 152 is illustrated in the examples shown here as being separate from the respective vMU 142 with which it is associated, it is to be understood that that each VTI 152 can also be implemented as a part of the vMU 142 with which it is associated. Also, the virtualization software 132 is configured so each virtual entity 136 also includes or communicates with a virtual Ethernet interface (VEI) 151 that virtualizes and controls access to the underlying other physical Ethernet interface 159.

The vDAS 140 is configured to serve each foreign base station 144 using a respective subset of the vDAS RUs 112 (which may include less than all of the vDAS RUs 112 of the vDAS 140). The subset of vDAS RUs 112 used to serve a given foreign base station 144 is also referred to here as the “simulcast zone” for that foreign base station 144. Typically, the simulcast zone for each foreign base station 144 includes multiple vDAS RUs 112. In this way, the vDAS 140 increases the coverage area for the capacity provided by the foreign base stations 144.

In general, the wireless coverage of a foreign base station 144 served by the vDAS 140 is improved by radiating a set of downlink RF signals for that foreign base station 144 from the coverage antennas 118 associated with the multiple vDAS RUs 112 in that base station's simulcast zone and by producing a single set of uplink base station signals by a combining or summing process that uses inputs derived from the uplink RF signals received via the coverage antennas 118 associated with the multiple vDAS RUs 112 in that base station's simulcast zone, where the resulting final single set of uplink base station signals is provided to the foreign base station 144.

This combining or summing process can be performed in a centralized manner in which the combining or summing process for each foreign base station 144 is performed by a single unit of the vDAS 140 (for example, by the associated vMU 142). This combining or summing process can also be performed for each foreign base station 144 in a distributed or hierarchical manner in which the combining or summing process is performed by multiple units of the vDAS 140 (for example, the associated vMU 142 and one or more ICNs and/or RUs 112). Each unit of the vDAS 140 that performs the combining or summing process for a given foreign base station 144 receives uplink transport data for that base station 144 from that unit's one or more “southbound” entities, combines or sums corresponding user-plane data contained in the received uplink transport data for that base station 144 as well as any corresponding user-plane data generated at that unit from uplink RF signals received via coverage antennas 118 associated with that unit (which would be the case if the unit is a “daisy-chained” RU 112), generates uplink transport data containing the combined user-plane data for that base station 144, and communicates the resulting uplink transport data for that base station 144 to the appropriate “northbound” entities coupled to that unit. As used here, “southbound” refers to traveling in a direction “away,” or being relatively “farther,” from the vMU 142 and foreign base station 144, and “northbound” refers to traveling in a direction “towards”, or being relatively “closer” to, the vMU 142 and foreign base station 144. As used here, the southbound entities of a given unit are those entities that are subtended from that unit in the southbound direction, and the northbound entities of a given unit are those entities from which the given unit is itself subtended from in the southbound direction.

The vDAS 140 can also include one or more intermediary or intermediate combining nodes (ICNs) (also referred to as “expansion” units or nodes) 143. For each foreign base station 144 that the vDAS 140 serves using an ICN 143, the ICN 143 is configured to receive a set of uplink transport data containing user-plane data for that base station 144 from a group of southbound entities (that is, from RUs 112 and/or other ICNs 143) and perform the uplink combining or summing process described above in order to generate uplink transport data containing combined user-plane data for that base station 144, which the ICN 143 transmits northbound towards the vMU 142 serving that base station 144. Each ICN 143 also forwards northbound all other uplink transport data (for example, uplink management-plane and synchronization-plane data) received from its southbound entities. In the embodiments shown here, the ICN 143 is communicatively coupled to its northbound entities and its southbound entities using the switched Ethernet network 122 and is used only for communicating uplink transport data and is not used for communicating downlink transport data. In such embodiments, each ICN 143 includes one or more Ethernet interfaces to communicatively couple the ICN 143 to the switched Ethernet network 122. For example, the ICN 143 can include one or more Ethernet interfaces that are used for communicating with its northbound entities and one or more Ethernet interfaces that are used for communicating with its southbound entities. Alternatively, the ICN 143 can communicate with both its northbound and southbound entities via the switched Ethernet network 122 using the same set of one or more Ethernet interfaces.

In some embodiments, the vDAS 140 is configured so that some ICNs 143 also communicate (forward) southbound downlink transport data received from their northbound entities (in addition to communicating uplink transport data).

Generally, ICNs 143 can be used to increase the number of RUs 112 that can be served by a vMU 142 while reducing the processing and bandwidth load relative to having the additional RUs 112 communicate directly with the vMU 142. Each ICN 143 can be implemented as a physical network function using dedicated, special-purpose hardware. Alternatively, each ICN 143 can be implemented as a virtual network function running on a physical server. For example, each ICN 143 can be implemented in the same manner as the vMU 142.

Also, one or more RUs 112 can be configured in a “daisy-chain” or “ring” configuration in which transport data for at least some of those RUs 112 is communicated via at least one other RU 112. Each such RU 112 would also perform the user-plane combining or summing process described above for any base station served by that RU 112 in order to combine or sum user-plane data generated at that RU 112 from uplink RF signals received via its associated coverage antennas 118 with corresponding uplink user-plane data for that base station received from any southbound entity subtended from that RU 112. Such an RU 112 also forwards northbound all other uplink transport data received from any southbound entity subtended from it and forwards to any southbound entity subtended from it all downlink transport received from its northbound entities.

In general, the vDAS 140 is configured to receive a set of downlink base station signals from each served foreign base station 144, generate downlink base station data for the base station 144 from the set of downlink base station signals, generate downlink transport data for the base station 144 that is derived from the downlink base station data for the base station 144, and communicate the downlink transport data for the base station 144 over the fronthaul network 120 of the vDAS 140 to the RUs 112 in the simulcast zone of the base station 144. Each RU 112 in the simulcast zone for each foreign base station 144 is configured to receive the downlink transport data for that base station 144 communicated over the fronthaul network 120 of the vDAS 140, generate a set of downlink analog radio frequency (RF) signals from the downlink transport data, and wirelessly transmit the set of downlink analog RF signals from the respective set of coverage antennas 118 associated with that RU 112. The downlink analog RF signals are radiated for reception by UEs 106 served by the base station 144. As described above, the downlink transport data for each foreign base station 144 can be communicated to each RU 112 in the base station's simulcast zone via one or more intermediary units of the vDAS 140 (such as one or more ICNs 143 or daisy-chained RUs 112). Also as described above, if an RU 112 is a part of a daisy chain, the RU 112 will also forward to any southbound entity subtended from that RU 112 all downlink transport received from its northbound entities.

The vDAS 140 is configured so that a vMU 142 associated with at least one foreign base station 144 performs at least some of the processing related to generating the downlink transport data that is derived from the downlink base station data for that base station 144 and communicating the downlink transport data for the base station 144 over the fronthaul network 120 of the vDAS 140 to the RUs 112 in the simulcast zone of the base station 144. In exemplary embodiments shown in FIG. 1, a respective vMU 142 does this for all of the served foreign base stations 144.

In general, each RU 112 in the simulcast zone of a foreign base station 144 receives one or more uplink RF signals transmitted from UEs 106 being served the base station 144. Each such RU 112 generates uplink transport data derived from the one or more uplink RF signals and transmits it over the fronthaul network 120 of the vDAS 140. As noted above, as a part of doing this, if the RU 112 is a part of daisy chain, the RU 112 performs the user-plane combining or summing process described above for the base station 144 in order to combine or sum user-plane data generated at that RU 112 from uplink RF signals received via its associated coverage antennas 118 for the base station 144 with any corresponding uplink user-plane data for that base station 144 received from any southbound entity subtended from that RU 112. Such a daisy-chained RU 112 also forwards northbound to its northbound entities all other uplink transport data received from any southbound entity subtended from that RU 112. As described above, the uplink transport data for each foreign base station 144 can be communicated from each RU 112 in the base station's simulcast zone over the fronthaul network 120 via one or more intermediary units of the vDAS 140 (such as one or more ICNs 143 or daisy-chained RUs 112).

The vDAS 140 is configured to receive uplink transport data for each foreign base station 144 from the fronthaul network 120 of the vDAS 140, use the uplink transport data for the base station 144 received from the fronthaul network 120 of the vDAS 140 to generate uplink base station data for the base station 144, generate a set of uplink base station signals from the uplink base station data for the base station 144, and provide the uplink base station signals to the base station 144. As a part of doing this, the user-plane combining or summing process can be performed for the base station 144.

The vDAS 140 is configured so that a vMU 142 associated with at least one foreign base station 144 performs at least some of the processing related to using the uplink transport data for the base station 144 received from the fronthaul network 120 of the vDAS 140 to generate the uplink base station data for the base station 144. In exemplary embodiments shown in FIG. 1, a respective vMU 142 does this for all of the served foreign base stations 144. As a part of performing this processing, the vMU 142 can perform at least some of the user-plane combining or summing process for the base station 144.

The vDAS 140 is configured so that the respective simulcast zone defined and used for each base station served by the vDAS 140 can be independently changed as needed (for example, to support different use cases for the venue in which the vDAS 140 is deployed). For example, the vDAS 140 can be deployed in a stadium or arena that is used for both sporting events (during which UEs 106 will typically not be located on the “field” or “court” portion of the stadium or arena and will typically only be located in the seating and other areas of the stadium or arena) and concerts or conventions (during which UEs 106 will typically be located on the “field” or “court” portion of the stadium or arena as well as in the seating and other areas of the stadium or arena). In such an example, different simulcast zones can be defined for each served base station for sporting events and for concerts or conventions and the vDAS 140 can be reconfigured as needed depending on the particular use case the stadium or arena is serving at any given time. The various simulcast zones can be defined and employed for the various served base stations using the RAN manager 163.

Also, for any foreign base station 144 coupled to the vDAS 140 using a CPRI fronthaul interface, the associated vMU 142 (and/or VDI 150 or physical donor interface 146) is configured to appear to that foreign base station 144 (that is, the associated BBU or DU) as a single RU or RRH of the type that the foreign base station 144 is configured to work with (for example, as a CPRI RU or RRH where the associated BBU or DU is coupled to the vDAS 100 using a CPRI fronthaul interface). As a part of doing this, the vMU 142 (and/or VDI 150 or physical donor interface 146) is configured to implement the control-plane, user-plane, synchronization-plane, and management-plane functions that such a RU or RRU would implement. Stated another way, in this example, the vMU 142 (and/or VDI 150 or physical donor interface 146) is configured to implement a single “virtual” RU or RRH for the associated foreign base station 144 even though multiple vDAS RUs 112 are actually being used to wirelessly transmit and receive RF signals for that foreign base station 144.

In some embodiments, at least one vMU 142 is configured to combine different base station sectors sourced from base stations from different mobile network operators (MNOs) that fall within the same RF band. This can be done so that these sectors can be simulcast from the same set of vDAS RUs 112 (that is, using the same simulcast zone). This type of combining is also referred to here as “sector-to-zone” (S2Z) combining. In one example of such an embodiment, a vMU 142 is configured to perform S2Z combining by digitally summing the downlink base station data for the multiple sectors in order to produce combined downlink transport data for distribution via the vDAS 140 to the vDAS RUs 112 in the simulcast zone. In other embodiments, S2Z combining is not performed in the vMU 142 and, instead, base station sectors sourced from the base stations of different mobile network operators (MNOs) are distributed to the vDAS RUs 112 using separate downlink transport data and where any combining occurs in the vDAS RUs 112. One advantage of using S2Z combining in the vMU 142 is higher efficiency of fronthaul bandwidth utilization.

In some implementations, the content of the transport data communicated between each vDAS RU 112 and a serving vMU 142 employs the same functional split used by the associated foreign base station 144 to interface with the vMU 142. In the exemplary embodiment shown in FIG. 1, each foreign base station 144 comprises either a “complete” base station that is coupled to a vMU 142 using an analog RF interface or a DU or BBU that is configured to use a CPRI front-haul interface. As a result, the data provided to the serving vMU 142 via the corresponding physical donor interface 146 reflects a functional split 8.

In some other implementations, the content of the transport data communicated between each vDAS RU 112 and a serving vMU 142 employs the same functional split used for the fronthaul interface between the DU 110 and the RUs 112 of the native base stations 102. In the exemplary embodiment shown in FIG. 1, functional split 7-2 is used for the fronthaul interface between the DU 110 and the RUs 112 of the native base stations 102. In such implementations, the vMU 142 converts the user plane data as needed (for example, by converting the time-domain user plane data to frequency-domain user plane data and generating associated control plane data).

In the exemplary embodiment shown in FIG. 1, the vDAS 140, and each vMU 142, ICN 143, and RU 112, is configured to use the time synchronization protocol (for example, the Institute of Electrical and Electronics Engineers (IEEE) 1588 Precision Time Protocol (PTP), the Synchronous Ethernet (SyncE) protocol, Network Time Protocol (NTP), and/or Global Positioning System (GPS)) used by the native base stations 102. The time synchronization protocol is used to synchronize itself to a timing master entity established for the RAN 100. In the event that a base station is coupled to the vDAS 140 using a physical RF donor interface 154, the vMU 142 is also configured to estimate the frame boundary of the downlink RF signals to align the transmit and receive offsets.

Each vMU 142 (and/or the associated VDIs 150) can also be configured to process the downlink user-plane and/or control-plane data for each foreign base station 144 in order to determine timing and system information for the foreign base station 144 and associated cell. This can involve processing the downlink user-plane and/or control-plane data for the donor base station 144 to perform the initial cell search processing a UE would typically perform in order to acquire time, frequency, and frame synchronization with the base station 144 and associated cell and to detect the Physical layer Cell ID (PCI) and other system information for the foreign base station 144 and associated cell (for example, by detecting and/or decoding the Primary Synchronization Signal (PSS), the Secondary Synchronization Signal (SSS), the Physical Broadcast Channel (PBCH), the Master Information Block (MIB), and System Information Blocks (SIBs)). This timing and system information for a foreign base station 144 can be used, for example, to configure the operation of the vDAS 140 (and the components thereof) in connection with serving that foreign base station 144.

In order to reduce the latency associated with implementing each vMU 142 or ICN 143 in a virtualized environment 134 running on a COTS physical server 130, input-output (IO) operations associated with communicating data between a vMU 142 and a physical donor interface 146 and/or between a vMU 142 and a physical transport interface 148, as well as any baseband processing performed by a vMU 142, associated VDI 150, or ICN 143 can be time-sliced to ensure that such operations are performed in a timely manner. With such an approach, the tasks and threads associated with such operations and processing are executed in dedicated times slices without such tasks and threads being preempted by, or otherwise having to wait for the completion of, other tasks or threads.

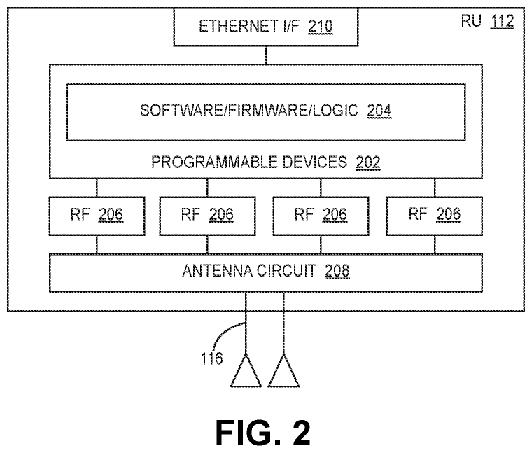

FIG. 2 is a block diagram illustrating one exemplary embodiment of an RU 112 that can be used in the vDAS 140 of FIG. 1.

The RU 112 comprises one or more programmable devices 202 that execute, or are otherwise programmed or configured by, software, firmware, or configuration logic 204 in order to implement at least some functions described here as being performed by the RU 112 (including, for example, physical layer (Layer 1) baseband processing described here as being performed by a radio unit (RU) entity implemented using that RU 112). The one or more programmable devices 202 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way. In general, the programmable devices 202 and software, firmware, or configuration logic 204 are scaled so as to be able implement multiple logical (or virtual) RU entities using the (physical) RU 112. The various functions described here as being performed by an RU entity are implemented by the programmable devices 202 and one or more of the RF modules 206 (described below) of the RU 112.

In general, each RU entity implemented by a vDAS RU 112 is associated with, and serves, one of the foreign base stations 144 coupled to the vDAS 140. The RU entity communicates transport data with each vMU 142 serving that vDAS RU 112 using the particular fronthaul interface used for communicating over the fronthaul network 120 and is configured to implement the associated fronthaul interface related processing (for example, formatting data in accordance with the fronthaul interface and implementing control-plane, management-plane, and synchronization-plane functions). The O-RAN fronthaul interface is used in the exemplary embodiment described here in connection with FIGS. 1 and 2. In addition, the RU entity performs any physical layer baseband processing that is required to be performed in the RU.

Normally, when a functional split 7-2 is used, some physical layer baseband processing is performed by the DU or BBU and the remaining physical layer baseband processing and the RF functions are performed by the corresponding RU. The physical layer baseband processing performed by the DU or BBU is also referred to as the “high” physical layer baseband processing, and the baseband processing performed by the RU is also referred to as the “low” physical layer baseband processing.

As noted above, in some implementations, the content of the transport data communicated between each vDAS RU 112 and a serving vMU 142 employs the same functional split used by the associated foreign base station 144 to interface with the vMU 142. In the exemplary embodiment shown in FIG. 1, each foreign base station 144 comprises either a “complete” base station that is coupled to a vMU 142 using an analog RF interface or a DU or BBU that is configured to a CPRI front-haul interface. As a result, the data provided to the serving vMU 142 via the corresponding physical donor interface 146 reflects a functional split 8.

In some other implementations, the content of the transport data communicated between each vDAS RU 112 and a serving vMU 142 employs the same functional split used for the fronthaul interface between the DU 110 and the RUs 112 of the native base stations 102. In the exemplary embodiment shown in FIG. 1, functional split 7-2 is used for the fronthaul interface between the DU 110 and the RUs 112 of the native base stations 102. In such implementations, the vMU 142 converts the user plane data as needed (for example, by converting the time-domain user plane data to frequency-domain user plane data and generating associated control plane data).

In general, the physical layer baseband processing required to be performed by an RU entity for a given served foreign base station 144 depends on the functional split used for the transport data.

In the exemplary embodiment shown in FIG. 2, the RU 112 comprises multiple radio frequency (RF) modules 206. Each RF module 206 comprises circuitry that implements the RF transceiver functions for a given RU entity implemented using that physical RU 112 and provides an interface to the coverage antennas 118 associated with that RU 112. Each RF module 206 can be implemented using one or more RF integrated circuits (RFICs) and/or discrete components.

Each RF module 206 comprises circuitry that implements, for the associated RU entity, a respective downlink and uplink signal path for each of the coverage antennas 118 associated with that physical RU 112. In one exemplary implementation, each downlink signal path receives the downlink baseband IQ data output by the one or more programmable devices 202 for the associated coverage antenna 118, converts the downlink baseband IQ data to an analog signal (including the various physical channels and associated sub carriers), upconverts the analog signal to the appropriate RF band (if necessary), and filters and power amplifies the analog RF signal. (The up-conversion to the appropriate RF band can be done directly by the digital-to-analog conversion process outputting the analog signal in the appropriate RF band or via an analog upconverter included in that downlink signal path.) The resulting amplified downlink analog RF signal output by each downlink signal path is provided to the associated coverage antenna 118 via an antenna circuit 208 (which implements any needed frequency-division duplexing (FDD) or time-division-duplexing (TDD) functions).

In one exemplary implementation, the uplink RF analog signal (including the various physical channels and associated sub carriers) received by each coverage antenna 118 is provided, via the antenna circuit 208, to an associated uplink signal path in each RF module 206.

Each uplink signal path in each RF module 206 receives the uplink RF analog received via the associated coverage antenna 116, low-noise amplifies the uplink RF analog signal, and, if necessary, filters and, if necessary, down-converts the resulting signal to produce an intermediate frequency (IF) version of the signal.

Each uplink signal path in each RF module 206 converts the resulting analog signals to real digital samples and outputs them to the one or more programmable logical devices 202 for uplink signal processing. (The analog-to-digital conversion process can be implemented using a direct RF ADC that can receive and digitize RF signals, in which case no analog down-conversion is necessary.)

Also, in this exemplary embodiment, for each coverage antenna 118, the antenna circuit 208 is configured to combine (for example, using one or more band combiners) the amplified analog RF signals output by the appropriate downlink signal paths of the various RF modules 206 for transmission using each coverage antenna 118 and to output the resulting combined signal to that coverage antenna 118. Likewise, in this exemplary embodiment, for each coverage antenna 118, the antenna circuit 208 is configured to split (for example, using one or more band filter and/or splitters) the uplink analog RF signals received using that coverage antenna 118 in order to supply, to the appropriate uplink signal paths of the RF modules 206 used for that antenna 118, a respective uplink analog RF signals for that signal path.

It is to be understood that the preceding description is one example of how each downlink and uplink signal path of each RF module 206 can be implemented; it is to be understood, however, that the downlink and uplink signal paths can be implemented in other ways.

The RU 112 further comprises at least one Ethernet interface 210 that is configured to communicatively couple the RU 112 to the fronthaul network 120 and, ultimately, to the vMU 142 and/or DU 110. For each port of each Ethernet interface 210, the Ethernet 210 is configured to communicate over the switched Ethernet network 122 implementing the fronthaul network 120.

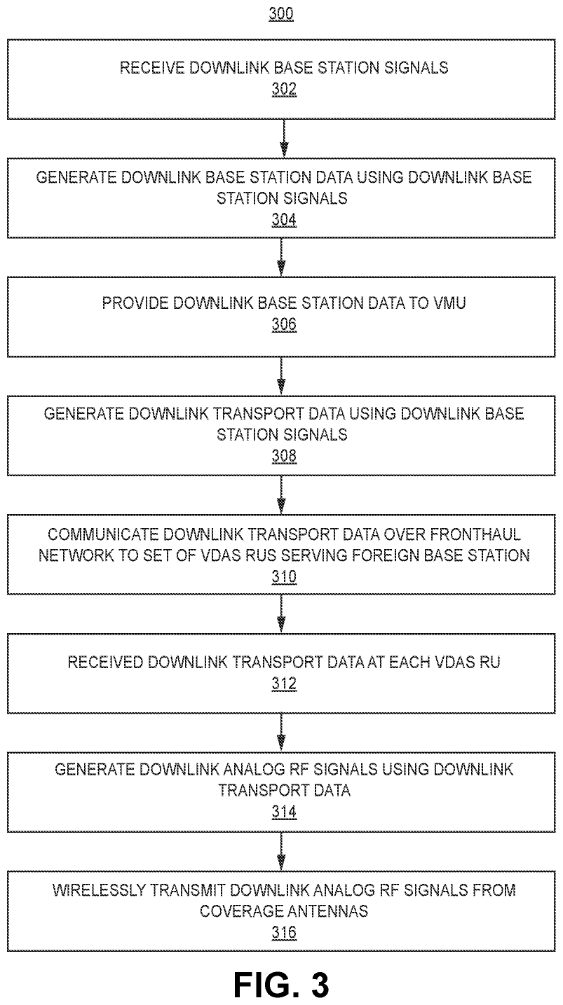

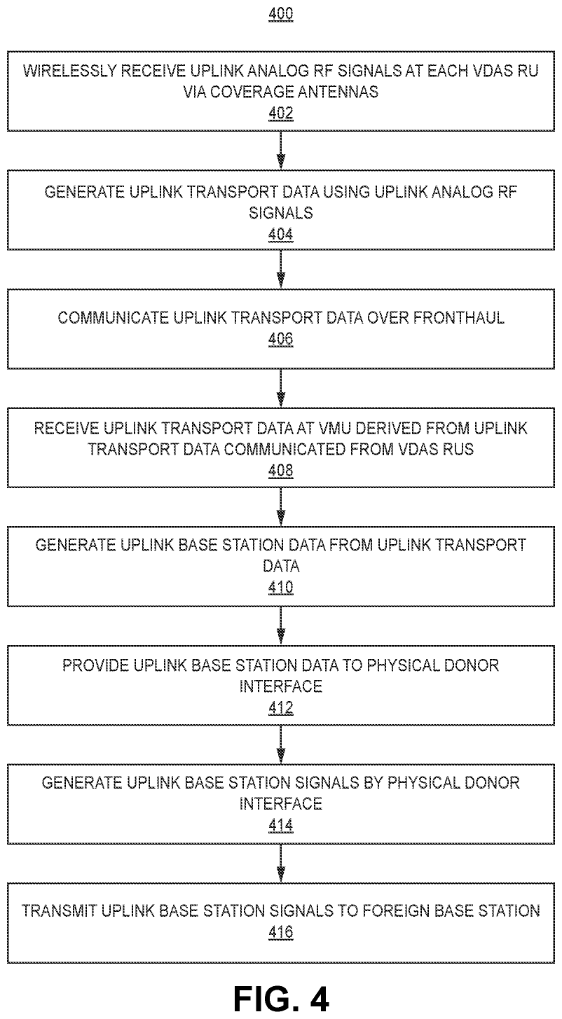

One example of the operation of the vDAS 140 is described below in connection with FIGS. 3 and 4.

FIG. 3 comprises a high-level flowchart illustrating one exemplary embodiment of a method 300 of providing wireless communication in a downlink direction using a foreign base station 144 coupled to a virtual distributed antenna system 140. The embodiment of method 300 shown in FIG. 3 is described here as being implemented using the vDAS 140 described above in connection with FIGS. 1 and 2. However, it is to be understood that other embodiments can be implemented in other ways.

The blocks of the flow diagram shown in FIG. 3 have been arranged in a generally sequential manner for ease of explanation; however, it is to be understood that this arrangement is merely exemplary, and it should be recognized that the processing associated with method 300 (and the blocks shown in FIG. 3) can occur in a different order (for example, where at least some of the processing associated with the blocks is performed in parallel and/or in an event-driven manner). Also, most standard exception handling is not described for ease of explanation; however, it is to be understood that method 300 can and typically would include such exception handling. Moreover, one or more aspects of method 300 can be configurable or adaptive (either manually or in an automated manner).

Method 300 shown in FIG. 3 is performed for each foreign base station 144 that is coupled to the vDAS 140, where each such foreign base station 144 is served by a respective set of vDAS RUs 112. The set of vDAS RUs 112 serving each foreign base station 144 is also referred to here as the “simulcast zone” for that foreign base station 144.

Method 300 comprises, by a physical donor interface 146, receiving one or more downlink base station signals from a foreign base station 144 (block 302), generating downlink base station data using the received downlink base station signals (block 304), and providing the downlink base station data to the vMU 142 (block 306).

The form that the downlink base station signals take and how the downlink base station data is generated from the downlink base station signals depends on how the base station 144 is coupled to the vDAS 140.

For example, where the foreign base station 144 is coupled to the vDAS 140 using an analog RF interface, the foreign base station 144 is configured to output from its antenna ports a set of downlink analog RF signals. Thus, in this example, the one or more downlink base station signals comprise the set of downlink analog RF signals output by the foreign base station 144 that would otherwise be radiated from a set of antennas coupled to the antenna ports of that base station 144. In this example, the physical donor interface 146 used to receive the downlink base station signals comprises a physical RF donor interface 154. Each of the downlink analog RF signals is received by a respective RF port of the physical RF donor interface 154 installed in the physical server computer 130 executing the vMU 142. The physical RF donor interface 154 is configured to receive each downlink analog RF signal (including the various physical channels and associated sub carriers) output by the foreign base station 144 and generate the downlink base station data by generating corresponding time-domain baseband in-phase and quadrature (IQ) data from the received download analog RF signals (for example, by performing an analog-to-digital (ADC) and digital down conversion process on the received downlink analog RF signal). The generated downlink base station data is provided to the vMU 142 (for example, by communicating it over a PCIe lane to a CPU used to execute each the vMU 142).

In another example, the foreign base station 144 comprises a BBU or DU that is coupled to the vDAS 140 using a CPRI fronthaul interface. In this example, the one or more downlink base station signals comprise the downlink CPRI fronthaul signal output by the base station 144 that would otherwise be communicated over a CPRI link to a RU. In this example, the physical donor interface 146 used to receive the one or more downlink base station signals comprises a physical CPRI donor interface 158. Each downlink CPRI fronthaul signal is received by a CPRI port of the physical CPRI donor interface 158 installed in the physical server computer 130 executing the vMU 142. The physical CPRI donor interface 158 is configured to receive each downlink CPRI fronthaul signal, generate downlink base station data by extracting various information flows that are multiplexed together in CPRI frames or messages that are communicated via the downlink CPRI fronthaul signal, and provide the generated downlink base station data to the vMU 142 (for example, by communicating it over a PCIe lane to a CPU used to execute the vMU 142). The extracted information flows can comprise CPRI user-plane data, CPRI control-and-management plane data, and CPRI synchronization-plane data. That is, in this example, the downlink base station data comprises the various downlink information flows extracted from the downlink CPRI frames received via the downlink CRPI fronthaul signals. Alternatively, the downlink base station data can be generated by extracting downlink CPRI frames or messages from each received downlink CPRI fronthaul signal, where the extracted CPRI frames are provided to the vMU 142 (for example, by communicating them over a PCIe lane to a CPU used to execute the vMU 142).

Method 300 further comprises generating, by the vMU 142, downlink transport data using the received downlink base station data (block 308) and communicating, using a physical transport Ethernet interface 166, the downlink transport data from the vMU 142 over the fronthaul network 120 to the set of vDAS RUs 112 serving the foreign base station 124 (block 310). As described above, the downlink transport data for each foreign base station 144 can be communicated to each vDAS RU 112 in the base station's simulcast zone via one or more intermediary units of the vDAS 140 (such as one or more ICNs 143 or daisy-chained RUs 112).

The generated downlink transport data is communicated over the fronthaul network 120 to the vDAS RUs 112 included in the simulcast zone of that foreign base station 144. In one example, a multicast group is established for each different simulcast zone assigned to any foreign base station 144 coupled to the vDAS 140. In such an example, the vMU 142 communicates the downlink transport data to the set of vDAS RUs 112 serving the foreign base station 144 by using one or more of the physical transport Ethernet interfaces 166 to transmit the downlink transport data as transport Ethernet packets addressed to the multicast group established for the simulcast zone associated with that foreign base station 144. In this example, the vMU 142 is configured so that a part of the process of generating the downlink transport data includes formatting the transport Ethernet packets to use the address of the multicast group established for that simulcast zone.

In another example, the vMU 142 broadcasts the downlink transport data to all of RUs 112 of the RAN 100 and each RU 112 is configured to determine if any downlink transport data it receives is intended for it. In this example, this can be done by including in the downlink transport data broadcast to the RUs 112 a bitmap field that includes a respective bit position for each RU 112 of the RAN 100. Each bit position is set to one value (for example, a “1”) if the associated downlink transport data is intended for that RU 112 and is set to a different value (for example, a “0”) if the associated downlink transport data is not intended for that RU 112. In one such example, the bitmap is included in a header portion of the underlying message so that the RU 112 does not need to decode the entire message in order to determine if the associated message is intended for it or not. In one implementation where the O-RAN fronthaul interface is used for the transport data, this can be done using an O-RAN section extension that is defined to include such a bitmap field in the common header fields. In this example, the vMU 142 is configured so that a part of the process of generating the downlink transport data includes formatting the downlink transport data to include a bitmap field, where the bit position for each vDAS RU 112 included in the base station's simulcast zone is set to the value (for example, a “1”) indicating that the data is intended for it and where the bit position for each RU 112 not included in the base station's simulcast zone is set to the other value (for example, a “0”) indicating that the data is not intended for it.

As a part of generating the downlink transport data, the vMU 142 performs any needed re-formatting or conversion of the received downlink base station data in order for it to comply with the format expected by the vDAS RUs 112 or for it to be suitable for use with the fronthaul interface used for communicating over the fronthaul network 120 of the vDAS 140. For example, in one exemplary embodiment described here in connection with FIGS. 1 and 2 where the vDAS 140 is configured to use an O-RAN fronthaul interface for communications between the vMU 142 and the RUs 112, the vDAS RUs 112 are configured for use with, and to expect, fronthaul data formatted in accordance with the O-RAN fronthaul interface. In such an example, if the downlink base station data provided from the physical donor interface 146 to the vMU 142 is not already formatted in accordance with the O-RAN fronthaul interface, the vMU 142 re-formats and converts the downlink base station data so that the downlink transport data communicated to the vDAS RUs 112 in the simulcast zone of the foreign base station 144 is formatted in accordance with the O-RAN fronthaul interface used by the vDAS RUs 112.

As noted above, in some implementations, the content of the transport data communicated between each vDAS RU 112 and a serving vMU 142 employs the same functional split used by the associated foreign base station 144 to interface with the vMU 142. In the exemplary embodiment shown in FIG. 1, each foreign base station 144 comprises either a “complete” base station that is coupled to a vMU 142 using an analog RF interface or a DU or BBU that is configured to a CPRI front-haul interface. As a result, the data provided to the serving vMU 142 via the corresponding physical donor interface 146 reflects a functional split 8.

In some other implementations, the content of the transport data communicated between each vDAS RU 112 and a serving vMU 142 employs the same functional split used for the fronthaul interface between the DU 110 and the RUs 112 of the native base stations 102. In the exemplary embodiment shown in FIG. 1, functional split 7-2 is used for the fronthaul interface between the DU 110 and the RUs 112 of the native base stations 102. In such implementations, the vMU 142 converts the user plane data as needed (for example, by converting the time-domain user plane data to frequency-domain user plane data and generating associated control plane data).

Method 300 further comprises receiving, by each of the vDAS RUs 112 associated with the foreign base station 144, the downlink transport data (block 312), generating, by each of the vDAS RUs 112 associated with the foreign base station 144, a respective set of downlink analog RF signals using the downlink transport data (block 314), and wirelessly transmitting, by each of the vDAS RUs 112 associated with the foreign base station 124, the respective set of analog RF signals from the respective set of coverage antennas 118 associated with each such vDAS RU 112 (block 316).

Where multicast addresses are used for transmitting the downlink transport data to the vDAS RUs 112 in a foreign base station's simulcast zone, each vDAS RU 112 in the simulcast zone will receive the downlink transport data transmitted by the vMU 142 using that multicast address.

Where downlink transport data is broadcast to all RUs 112 of the RAN 100 and the downlink transport data includes a bitmap field to indicate which RUs 112 the data is intended for, all RUs 112 of RAN 100 will receive the downlink transport data transmitted by the vMU 142 for a foreign base station 144 but the bitmap field will be populated with data in which only the bit positions associated with the vDAS RUs 112 in the foreign base station's simulcast zone will be set to the bit value indicating that the data is intended for them and the bit positions associated with the other RUs 112 will be set to the bit value indicating that the data is not intended for them. As a result, only those vDAS RUs 112 in the base station's simulcast zone will fully process such downlink transport data and the other RUs 112 will discard the data after determining that it is not intended for them.

As noted above, how each vDAS RU 112 generates the set of downlink analog RF signals using the downlink transport data depends on the functional split used for communicating transport data between the vMUs 142 and the vDAS RUs 112. For example, where the downlink transport data that is communicated between the vMU 142 and the vDAS RUs 112 in the foreign base station's simulcast zone comprises frequency-domain user-plane data and associated control-plane data for each antenna port of the foreign base station 144, a RU entity implemented by each vDAS RU 112 is configured to perform the low physical layer baseband processing and RF functions for each antenna port of the foreign base station 144 using the respective downlink transport data. This is done in order to generate a corresponding downlink RF signal for wireless transmission from a respective coverage antenna 118 associated with that vDAS RU 112. Where the downlink transport data that is communicated between the vMU 142 and the vDAS RUs 112 in the foreign base station's simulcast zone comprises time-domain user-plane data and associated control-plane data for each antenna port of the foreign base station 144, a RU entity implemented by each vDAS RU 112 is configured to perform the RF functions for each antenna port of the foreign base station 144 using the respective downlink transport data. This is done in order to generate a corresponding downlink RF signal for wireless transmission from a respective coverage antenna 118 associated with that vDAS RU 112.

FIG. 4 comprises a high-level flowchart illustrating one exemplary embodiment of a method 400 of providing wireless communication in an uplink direction using a foreign base station 144 coupled to a virtual distributed antenna system 140. The embodiment of method 400 shown in FIG. 4 is described here as being implemented using the vDAS 140 described above in connection with FIGS. 1 and 2. However, it is to be understood that other embodiments can be implemented in other ways.

The blocks of the flow diagram shown in FIG. 4 have been arranged in a generally sequential manner for ease of explanation; however, it is to be understood that this arrangement is merely exemplary, and it should be recognized that the processing associated with method 400 (and the blocks shown in FIG. 4) can occur in a different order (for example, where at least some of the processing associated with the blocks is performed in parallel and/or in an event-driven manner). Also, most standard exception handling is not described for ease of explanation; however, it is to be understood that method 400 can and typically would include such exception handling. Moreover, one or more aspects of method 400 can be configurable or adaptive (either manually or in an automated manner).

Method 400 shown in FIG. 4 is performed for each foreign base station 144 that is coupled to the vDAS 140, where each such foreign base station 144 is served by a respective set of vDAS RUs 112 (that is, the vDAS RUs 112 in the simulcast zone for that foreign base station 144).

Method 400 comprises wirelessly receiving, by each vDAS RU 112 included in the simulcast zone of the associated foreign base station 144, a respective set of uplink RF analog signals (including the various physical channels and associated sub carriers) via the set of coverage antennas 118 associated with that vDAS RU 112 (block 402), generating uplink transport data from the received uplink RF analog signals (block 404), and communicating the uplink transport data from each vDAS RU 112 over the fronthaul network 120 of the vDAS 140 (block 406). The uplink transport data is communicated over the fronthaul network 120 to the vMU 142 coupled to the foreign base station 144.

As noted above, how each vDAS RU 112 generates the uplink transport data from the set of uplink analog RF signals depends on the functional split used for communicating transport data between the vMUs 142 and the vDAS RUs 112. Where the uplink transport data that is communicated between each vDAS RU 112 in the foreign base station's simulcast zone and the serving vMU 142 comprises frequency-domain user-plane data for each antenna port of the foreign base station 144, an RU entity implemented by each vDAS RU 112 is configured to perform the RF functions and low physical layer baseband processing for each antenna port of the foreign base station 144 using the respective uplink analog RF signal. This is done in order to generate the corresponding uplink transport data for transmission over the fronthaul network 120 to the serving vMU 142. Where the uplink transport data that is communicated between each RU 112 in the foreign base station's simulcast zone and the serving vMU 142 comprises time-domain user-plane data for each antenna port of the foreign base station 144, an RU entity implemented by each vDAS RU 112 is configured to perform the RF functions for each antenna port of the foreign base station 144 using the respective uplink analog RF signal. This is done in order to generate the corresponding uplink transport data for transmission over the fronthaul network 120 to the serving vMU 142.

Method 400 further comprises receiving, by the vMU 142 coupled to the foreign base station 144, uplink transport data derived from the uplink transport data transmitted from the vDAS RUs 112 in the simulcast zone of the foreign base station 144 (block 408), generating uplink base station data from the uplink transport data (block 410), providing the uplink base station data to the physical donor interface 146 coupled to the foreign base station 144 (block 412), generating, by the physical donor interface 146 coupled to the foreign base station 144, one or more uplink base station signals from the uplink base station data (block 414), and transmitting the one or more uplink base station signals to the foreign base station 144 (block 416). As described above, the uplink transport data can be communicated from the RUs 112 in the simulcast zone of the foreign base station 144 to the vMU 142 coupled to the foreign base station 144 via one or more intermediary units of the vDAS 140 (such as one or more ICNs 143 or daisy-chained RUs 112).

As described above, a single set of uplink base station signals is produced for each foreign base station 144 using a combining or summing process that uses inputs derived from the uplink RF signals received via the coverage antennas 118 associated with the vDAS RUs 112 in that base station's simulcast zone, where the resulting final single set of uplink base station signals is provided to the base station 144. Also, as noted above, this combining or summing process can be performed in a centralized manner in which the combining or summing process for each base station 144 is performed by a single unit of the vDAS 140 (for example, by the associated vMU 142). This combining or summing process can also be performed for each foreign base station 144 in a distributed or hierarchical manner in which the combining or summing process is performed by multiple units of the vDAS 140 (for example, the associated vMU 142 and one or more ICNs 143 and/or RUs 112).

How the corresponding user-plane data is combined or summed depends on the functional split used for communicating transport data between the vMUs 142 and the vDAS RUs 112. Where the uplink transport data communicated between the vMUs 142 and the vDAS RUs 112 comprises frequency-domain baseband IQ data, each unit of the vDAS 100 that performs the combining or summing process (including the vMU 142) for a given foreign base station 144 is configured to extract, from the uplink transport data received from each of its southbound entities, the respective frequency-domain baseband IQ data for each uplink antenna port of the foreign base station 144 and digitally sum the baseband IQ data associated with each resource element received from each of its southbound entities as well any baseband IQ data associated with each resource element generated at that unit from uplink RF signals received via a coverage antenna 118 associated with that unit (which would be the case if the unit performing the combining or summing process is a “daisy-chained” RU 112). That is, the digital summing is performed on a resource-element-by-resource-element basis in this example. In this example where the uplink transport data communicated between the vMUs 142 and the RUs 112 comprises frequency-domain baseband IQ data, if the foreign base station 144 comprises a DU or BBU that is configured to use functional split 8 or if the foreign base station 144 comprises a “complete” base station that is coupled to the vDAS 140 using an analog RF interface, for each upstream antenna port of the foreign base station 144, the vMU 142 is also configured to convert the summed frequency-domain baseband IQ data to time-domain baseband IQ data.

Where the uplink transport data communicated between the vMUs 142 and the vDAS RUs 112 comprises time-domain baseband IQ data, each unit of the vDAS 100 that performs the combining or summing process (including the vMU 112) for a given base station 124 is configured to extract, from the uplink transport data received from each of its southbound entities, the respective time-domain baseband IQ data for each uplink antenna port of the foreign base station 144 and digitally sum the baseband IQ data associated with each sample period received from each of its southbound entities as well any baseband IQ data associated with each sample period generated at that unit from uplink RF signals received via a coverage antenna 116 associated with that unit (which would be the case if the unit performing the combining or summing process is a “daisy-chained” AP 114). That is, the digital summing is performed on a sample-period-by-sample-period basis in this example.

The form that the uplink base station signals take and how the uplink base station signals are generated from the uplink base station data also depend on how the foreign base station 144 is coupled to the vDAS 140.

For example, where a CPRI-based fronthaul interface is used for communications between the physical donor interface 146 and the foreign base station 144, in one implementation, the uplink base station data comprises the various information flows that are multiplexed together in uplink CPRI frames or messages and the vMU 142 is configured to format the uplink base station data into messages formatted in accordance with the CPRI fronthaul interface. In such an implementation, the information flows are provided to the associated physical CPRI donor interface 158. The physical CPRI donor interface 158 uses these information flows to generate CPRI frames for communicating to the foreign base station 144 via one or more CPRI ports of that physical CPRI donor interface 148. That is, in this example, the “uplink base station signals” comprise the physical-layer signals used to communicate such CPRI frames. Alternatively, in another implementation, the uplink base station data comprises CPRI frames or messages, which the vMU 142 is configured to produce and provide to the associated physical CPRI donor interface 158 for use in producing the physical-layer signals used to communicate the CPRI frames to the base station 144.

Where an analog RF interface is used for communications between the physical donor interface 146 and the foreign base station 144, the vMU 142 is configured to provide the uplink base station data (comprising the combined (that is, digitally summed) time-domain baseband IQ data for each antenna port of the foreign base station 144) to the associated physical RF donor interface 154. The physical RF donor interface 154 uses the provided uplink base station data to generate an uplink analog RF signal for each antenna port of the foreign base station 144 (for example, by performing a digital up conversion and digital-to-analog (DAC) process). For each antenna port of the foreign base station 144, the physical RF donor interface 154 outputs the respective uplink analog RF signal (including the various physical channels and associated sub carriers) to that antenna port using the appropriate RF port of the physical RF donor interface 154. That is, in this example, the “uplink base station signals” comprise the uplink analog RF signals output by the physical RF donor interface 154.

By implementing one or more nodes or functions of a traditional DAS (such as a CAN or TEN) using, or as, one or more VNFs 128 executing on one or more physical server computers 130, such nodes or functions can be implemented using COTS servers (for example, COTS servers of the type deployed in data centers or “clouds” maintained by enterprises, communication service providers, or cloud services providers) instead of custom, dedicated hardware. As a result, such nodes and functions can be deployed more cheaply and in a more scalable manner (for example, additional capacity can be added by instantiating additional VNFs 128 as needed). This is the case even if an additional physical server computer 130 is needed in order to instantiate a new vMU 142 or ICN 143 because such physical server computers 130 are either already available in such deployments or can be easily added at a low cost (for example, because of the COTS nature of such hardware).

As noted above, this approach is especially well-suited for use in deployments in which base stations from multiple wireless service operators desire to provide wireless service using the same set of RUs 112 (including, for example, neutral host deployments or deployments where one wireless service operator owns the vDAS 100 and provides other wireless service operators with access to its vDAS 100). Also, as noted above, this approach is also well-suited for use in deployments with legacy base stations (for example, 4G LTE base stations) to improve the wireless coverage provided by such base stations using the same set of RUs 112 that are also used to implement current generation base station entities (for example, 5G NR base stations), where the legacy base stations do not natively support using the RUs 112 used to implement the current generation base station entities.

Other embodiments can be implemented in other ways. For example, as shown in FIG. 5, the vMU 142 and DU 110 can be implemented in different virtual entities 130 (for example, in different containers or pods).

Also, as shown in FIG. 6, the vDAS 140 can include at least one physical RF donor 654 that is configured to bypass the vMU 142 and instead, for foreign base stations 144 coupled to that physical RF donor 654, have that physical RF donor 654 perform at least some of the functions described above as being performed by the vMU 142. These functions include, for the downlink direction, receiving a set of downlink RF analog signals from each base station 144 coupled to the by-pass physical RF donor 654, generating downlink transport data from the set of downlink RF analog signals and communicating the downlink transport data to the various vDAS RUs 112 or ICNs 143 and, in the uplink direction, receiving respective uplink transport data from the various vDAS RUs 112 or ICNs 143, generating a set of uplink RF analog signals from the received uplink transport data (including performing any digital combining or summing of user-plane data), and providing the uplink RF analog signals to the appropriate base stations 144. In this exemplary embodiment, each by-pass physical RF donor 654 includes one or more physical Ethernet transport interfaces 668 for communicating the transport data to and from the various vDAS RUs 112 and/or ICNs 143.

Each by-pass physical RF donor interface 654 comprises one or more programmable devices 650 that execute, or are otherwise programmed or configured by, software, firmware, or configuration logic 652 in order to implement at least some of the functions described here as being performed by the by-pass physical RF donor interface 654 (including, for example, any necessary physical layer (Layer 1) baseband processing). The one or more programmable devices 650 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way.

The physical RF donor 654 can be used to reduce the overall latency associated with serving the foreign base stations 144 coupled to that physical RF donor 654 using an analog RF interface. Moreover, the by-pass physical RF donor 654 can be implemented as a standalone unit that is separate from the physical server on which any other vMU 142 or DU 110 is implemented (as shown in FIG. 6) or can be integrated into a physical server used to implement some other function of the RAN 100 (for example, a physical server that is used to implement a vMU 142 of the vDAS 140). Also, the physical RF donor 654 need not be co-located with the physical servers used to implement other functions of the RAN 100.

In one implementation, the by-pass physical RF donor interface 654 is configured to operate in a fully standalone mode in which the by-pass physical RF donor interface 654 performs substantially all “master unit” processing for the foreign base stations 144, RUs, and ICNs 143 that it serves. For example, in such a fully standalone mode, in addition to the processing associated with generating and communicating user-plane and control-plane data over the fronthaul network 120, the by-pass physical RF donor interface 654 can also execute software that is configured to use a time synchronization protocol (for example, the IEEE 1588 PTP or SyncE protocol) to synchronize the by-pass physical RF donor interface 654 to a timing master entity established for the vDAS 140. In such a mode, the by-pass physical RF donor interface 654 can itself serve as a timing master for the RUs 112 and other nodes (for example, ICNs 143) served by that by-pass physical RF donor interface 654 or instead have another entity serve as a timing master for the RUs 112 and other nodes (for example, ICNs 143) served by that by-pass physical RF donor interface 654.

In such a fully standalone mode, the by-pass physical RF donor interface 654 can also execute software that is configured to process the downlink user-plane and/or control-plane data for each foreign base station 144 coupled to it in order to determine timing and system information for the base station 144 and associated cell (which, as described above, can involve processing the downlink user-plane and/or control-plane data to perform the initial cell search processing a UE would typically perform in order to acquire time, frequency, and frame synchronization with the base station 144 and associated cell and to detect the PCI and other system information for the base station 144 and associated cell (for example, by detecting and/or decoding the PSS, the SSS, the PBCH, the MIB, and SIBs). This timing and system information for a foreign base station 144 can be used, for example, to configure the operation of the by-pass physical RF donor interface 654 and/or the vDAS 140 (and the components thereof) in connection with serving that base station 144. In such a fully standalone mode, the by-pass physical RF donor interface 654 can also execute software that enables the by-pass physical RF donor interface 654 to exchange management-plane messages with the RUs and other nodes (for example, ICNs) served by that by-pass physical RF donor interface 654 as well as with any external management entities coupled to it.

In other modes of operation, at least some of the “master unit” processing for the foreign base stations 144, RUs 112, and ICNs 143 that the by-pass physical RF donor interface 654 serves are performed by a vMU 142. For example, the vMU 142 can serve as a timing master and the by-pass physical RF donor interface 654 can execute software that causes the by-pass physical RF donor interface 654 to serve as a timing sub-ordinate and exchange timing messages with the vMU 142 to enable the by-pass physical RF donor interface 654 to synchronize itself to the timing master. In such other modes, the by-pass physical RF donor interface 654 can itself serve as a timing master for the RUs 112 and other nodes (for example, ICNs 143) served by that by-pass physical RF donor interface 654 or instead have the vMU 142 (or other entity) serve as a timing master for the RUs 112 or other nodes (for example, ICNs 143) served by that by-pass physical RF donor interface 654. In such other modes, the vMU 142 can also execute software that is configured to process the downlink user-plane and/or control-plane data for each foreign base station 144 served by the by-pass physical RF donor interface 654 in order to determine timing and system information for the foreign base station 144 and associated cell. In connection with doing this, the by-pass physical RF donor interface 654 provides the required downlink user-plane and/or control-plane data to the vMU 112. In such other modes, the vMU 142 can also execute software that enables it to exchange management-plane messages with the by-pass physical RF donor interface 654 and the RUs 112 and other nodes (for example, ICNs 143) served by the by-pass physical RF donor interface 654 as well as with any external management entities coupled to it. In such other modes, data or messages can be communicated between the by-pass physical RF donor interface 654 and the vMU 142, for example, over the fronthaul switched Ethernet network 122 (which is suitable if the by-pass physical RF donor interface 654 is physically separate from the physical server computer 130 used to execute the vMU 142) or over a PCIe lane to a CPU used to execute the vMU 142 (which is suitable if the by-pass physical RF donor interface 654 is implemented as a card inserted into a slot of the physical server computer 130 used to execute the vMU 142).

The by-pass physical RF donor interface 654 can be configured and used in other ways.

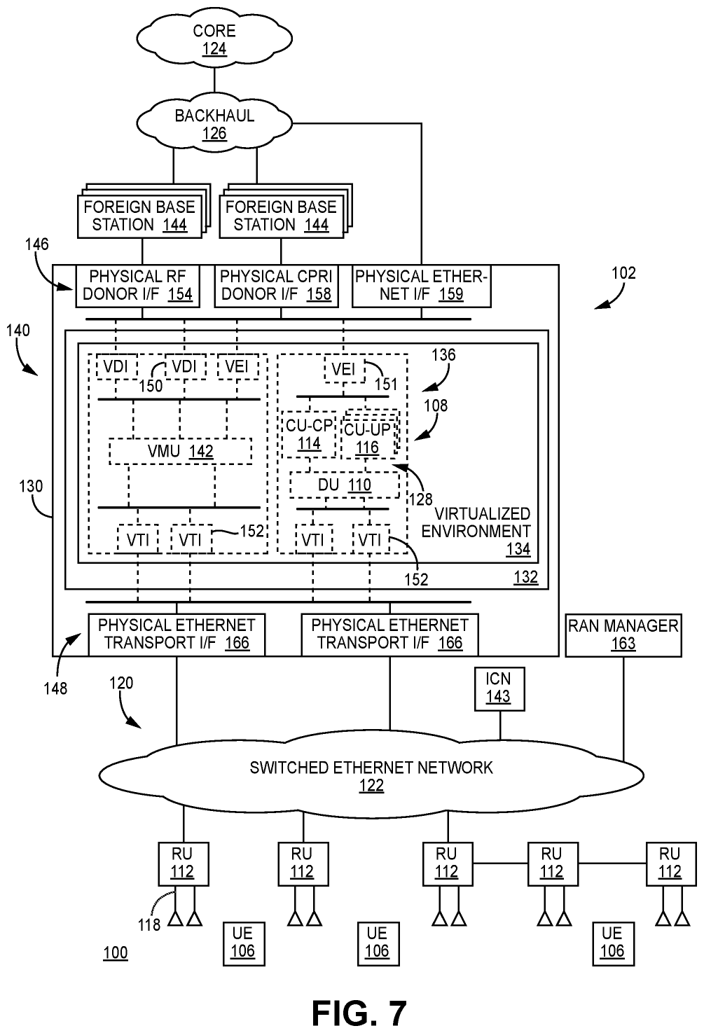

Moreover, the CU 108 can be implemented on the same physical server 130 as the associated DU 110 and/or vMU 142. For example, as shown in FIG. 7, the CU-CP 114 and each CU-UP 116 can be implemented in the same virtual entity 130 as the associated DU 110. Again, this is only one exemplary deployment scenario and the various entities (for example, CU 108, CU-CP 114, CU-UP 116, DU 110, vMU 142, and/or physical RF donor 654) can be deployed in other ways.

Furthermore, the fronthaul network 120 can be implemented in other ways. For example, the fronthaul network 120 can be implemented using only point-to-point Ethernet links, where each RU 112 is coupled to each serving vMU 142 and/or DU 110 serving it via a respective one or more point-to-point Ethernet links. The fronthaul network 120 can also be implemented using a combination of a switched Ethernet network and point-to-point Ethernet links.

In other examples, at least some vDAS RUs 112 can be coupled to one or more vMUs 142 serving them via one or more intermediate combining nodes (ICNs), where each such ICN comprises at least one northbound Ethernet interface used primarily for communicating with the one or more vMUs 142 (or another other northbound ICN) and a plurality of southbound Ethernet interfaces used primarily for communicating with any vDAS RUs 112 or other ICNs subtended from it.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

### EXAMPLE EMBODIMENTS

Example 1 includes a radio access network (RAN) comprising: a set of one or more physical server computers configured to execute virtualization software that creates a virtualized environment, wherein the set of physical server computers is configured to instantiate and execute a set of one or more virtual network functions (VNFs) used to implement at least one native base station and a virtual master unit (vMU) of a virtual distributed antenna system (vDAS), wherein the vDAS is configured to serve a foreign base station; and a plurality of radio units (RUs), each of the RUs associated with a respective set of coverage antennas; wherein the set of physical server computers is communicatively coupled to the plurality of RUs using a fronthaul network; wherein the vDAS is configured to receive a set of downlink base station signals from a foreign base station and generate downlink base station data from the set of downlink base station signals; wherein the vMU is configured to generate downlink transport data derived from the downlink base station data and communicate the downlink transport data to one or more of the RUs; wherein each of said one or more of the RUs is configured to receive the downlink transport data, generate a set of downlink analog radio frequency (RF) signals from the downlink transport data, and wirelessly transmit the set of downlink analog RF signals from the respective set of coverage antennas associated with that RU; wherein each of said one or more of the RUs is configured to receive a respective set of uplink analog RF signals via the respective set of coverage antennas associated with that RU, generate respective uplink transport data from the respective set of uplink analog RF signals, and communicate the uplink transport data over the fronthaul network; wherein the vMU is configured to receive uplink transport data derived from the uplink transport communicated over the fronthaul network by each of said one or more of the RUs and generate uplink base station data from the uplink transport data received by the vMU; and wherein the vDAS is configured to generate a set of uplink base station signals from the uplink base station data and provide the set of uplink base station signals to the foreign base station.

Example 2 includes the RAN of Example 1, wherein the vMU is configured to generate the uplink base station data from the uplink transport data received by the vMU by combining user-plane data included in the uplink transport data received from by the vMU.

Example 3 includes the vDAS of any of Example 1-2, wherein each of the set of physical server computers comprises at least one physical transport Ethernet interface; and wherein the physical server computer used implement the vMU comprises at least one physical donor interface to couple the physical server computer to the foreign base station.

Example 4 includes the RAN of Example 3, wherein the physical donor interface comprises a physical analog RF donor interface configured to: receive the set of downlink base station signals from the foreign base station as a set of downlink analog RF signals and to generate the downlink base station data from the set of downlink base station signals by performing an analog-to-digital process on the downlink analog RF signals in order to generate the downlink base station data; generate the set of uplink base station signals from the uplink base station data by performing by a digital-to-analog process on the uplink base station data in order to generate a set of uplink analog RF signals; and provide the uplink analog RF signals to the foreign base station.

Example 5 includes the RAN of any of Examples 3-4, wherein the physical donor interface comprises a physical Common Public Radio Interface (CPRI) donor interface configured to: receive the set of downlink base station signals from the foreign base station as a set of downlink CPRI signals; generate the downlink base station data from the set of downlink CPRI signals; generate the set of uplink base station signals from the uplink base station data as a set of uplink CPRI signals; and provide the set of uplink CPRI signals to the foreign base station.

Example 6 includes the RAN of any of Examples 1-5, wherein the vDAS comprises a plurality of vMUs, each of the vMUs serving a different wireless service operator, each of the plurality of vMUs are communicatively coupled to a respective set of foreign base stations.

Example 7 includes the RAN of any of Examples 1-6, wherein the virtualization software is configured to dynamically instantiate VNFs to implement one or more vMUs.

Example 8 includes the RAN of any of Examples 1-7, wherein the vDAS is configured to serve multiple foreign base stations.

Example 9 includes the RAN of any of Examples 1-8, wherein the vDAS is configured to serve multiple base stations from multiple wireless service providers.

Example 10 includes the RAN of any of Examples 1-9, wherein the vDAS is configured to serve multiple base stations implementing multiple different radio access technologies, multiple base stations using multiple different RF bands or bandwidths, and/or multiple base stations implemented using different technology.

Example 11 includes the RAN of any of Examples 1-10, wherein the physical server computer used to implement the vMU is configured to time slice execution of at least some operations and/or processing performed by the vMU.

Example 12 includes the RAN of any of Examples 1-11, wherein the physical server computer used to implement the vMU is configured to time slice execution of at least one of: at least one input-output (IO) operation performed by the vMU and at least some baseband processing performed by the vMU.

Example 13 includes the RAN of any of Examples 1-12, wherein the vDAS further comprises an intermediate combining node (ICN); and wherein at least one of said one or more of the RUs communicates the respective uplink transport data via the ICN.

Example 14 includes the RAN of Example 13, wherein the ICN is implemented as one of: a physical network function using dedicated special-purpose hardware; and a virtual network function using a physical server.

Example 15 includes the RAN of any of Examples 1-14, wherein at least one of said one or more of the RUs communicates the respective uplink transport data via at least one other RU.

Example 16 includes the RAN of any of Examples 1-15, further comprising a by-pass physical analog RF donor interface configured to by-pass the vMU; and wherein said by-pass physical analog RF donor interface is configured to: receive, from the foreign base station, a set of downlink analog RF signals, generate downlink transport data, and communicate the downlink transport data to one or more RUs via the fronthaul network; and receive uplink transport data derived from the uplink transport communicated over the fronthaul network by each of said one or more of the RUs, generate a set of uplink base station signals from the uplink transport data received by said by-pass physical analog RF donor interface, and provide the set of uplink base station signals to the foreign base station.

Example 17 includes a method of providing wireless communication using a radio access network (RAN) comprising a set of one or more physical server computers configured to execute virtualization software that creates a virtualized environment, wherein the set of physical server computers is configured to instantiate and execute a set of one or more virtual network functions (VNFs) used to implement at least one native base station and a virtual master unit (vMU) of a virtual distributed antenna system (vDAS), the vDAS configured to serve a foreign base station, the RAN further comprising a plurality of radio units (RUs), each of the RUs associated with a respective set of coverage antennas, wherein the set of physical server computers is communicatively coupled to the plurality of RUs using a fronthaul network, the method comprising: receiving a set of downlink base station signals from the foreign base station; generating downlink base station data from the set of downlink base station signals; generating, by the vMU, downlink transport data derived from the downlink base station data; communicating, by the vMU, the downlink transport data to one or more of the RUs; receiving, by each of the one or more RUs, the downlink transport data; generating a respective set of downlink analog radio frequency (RF) signals from the downlink transport data; wirelessly transmitting the respective set of downlink analog RF signals from the respective set of coverage antennas associated with that RU; wirelessly receiving, by each of said one or more of the RUs, a respective set of uplink analog RF signals via the respective set of coverage antennas associated with that RU; generating, by each of said one or more of the RUs, respective uplink transport data from the respective set of uplink analog RF signals received by that RU; communicating, by each of said one or more of the RUs, the respective uplink transport data over the fronthaul network; receiving, by the vMU, uplink transport data derived from the respective uplink transport data communicated from each of said one or more of the RUs; generating, by the vMU, uplink base station data from the uplink transport data received from all of said one or more of the RUs; generating a set of uplink base station signals from the uplink base station data; and providing the set of uplink base station signals to the foreign base station.

Example 18 includes the method of Example 17, wherein generating the uplink base station data from the uplink transport data received by the vMU comprises combining user-plane data included in the uplink transport data received from by the vMU.

Example 19 includes the method of any of Examples 17-18, wherein each of the set of physical server computers comprises at least one physical transport Ethernet interface; and wherein the physical server computer used implement the vMU comprises at least one physical donor interface to couple the physical server computer to the foreign base station.

Example 20 includes the method of Example 19, wherein the physical donor interface comprises a physical analog RF donor interface configured to: receive the set of downlink base station signals from the foreign base station as a set of downlink analog RF signals and to generate the downlink base station data from the set of downlink base station signals by performing an analog-to-digital process on the downlink analog RF signals in order to generate the downlink base station data; generate the set of uplink base station signals from the uplink base station data by performing by a digital-to-analog process on the uplink base station data in order to generate a set of uplink analog RF signals; and provide the uplink analog RF signals to the foreign base station.

Example 21 includes the method of any of Examples 19-20, wherein the physical donor interface comprises a physical Common Public Radio Interface (CPRI) donor interface configured to: receive the set of downlink base station signals from the foreign base station as a set of downlink CPRI signals; generate the downlink base station data from the set of downlink CPRI signals; generate the set of uplink base station signals from the uplink base station data as a set of uplink CPRI signals; and provide the set of uplink CPRI signals to the foreign base station.

Example 22 includes the method of any of Examples 17-21, wherein the vDAS comprises a plurality of vMUs, each of the vMUs serving a different wireless service operator, each of the plurality of vMUs are communicatively coupled to a respective set of foreign base stations.

Example 23 includes the method of any of Examples 17-22, wherein the virtualization software is configured to dynamically instantiate VNFs to implement one or more vMUs.

Example 24 includes the method of any of Examples 17-23, wherein the vDAS is configured to serve multiple foreign base stations.

Example 25 includes the method of any of Examples 17-24, wherein the vDAS is configured to serve multiple base stations from multiple wireless service providers.

Example 26 includes the method of any of Examples 17-25, wherein the vDAS is configured to serve multiple base stations implementing multiple different radio access technologies, multiple base stations using multiple different RF bands or bandwidths, and/or multiple base stations implemented using different technology.

Example 27 includes the method of any of Examples 17-26, wherein the physical server computer used to implement the vMU is configured to time slice execution of at least some operations and/or processing performed by the vMU.

Example 28 includes the method of any of Examples 17-27, wherein the physical server computer used to implement the vMU is configured to time slice execution of at least one of: at least one input-output (IO) operation performed by the vMU and at least some baseband processing performed by the vMU.

Example 29 includes the method of any of Examples 17-28, wherein the vDAS further comprises an intermediate combining node (ICN); and wherein communicating, by each of said one or more of the RUs, the respective uplink transport data over the fronthaul network comprises communicating, by each of said one or more of the RUs, the respective uplink transport data via the ICN.

Example 30 includes the method of Example 29, wherein the ICN is implemented as one of: a physical network function using dedicated special-purpose hardware; and a virtual network function using a physical server.

Example 31 includes the method of any of Examples 17-30, wherein communicating, by each of said one or more of the RUs, the respective uplink transport data over the fronthaul network comprises communicating, by at least one of said one or more of the RUs, the respective uplink transport data via at least one other RU.

Example 32 includes the method of any of Examples 17-31, wherein the vDAS further comprises a by-pass physical analog RF donor interface configured to by-pass the vMU; and wherein said by-pass physical analog RF donor interface is configured to: receive, from the foreign base station, a set of downlink analog RF signals, generate downlink transport data, and communicate the downlink transport data to one or more RUs via the fronthaul network; and receive uplink transport data derived from the uplink transport communicated over the fronthaul network by each of said one or more of the RUs, generate a set of uplink base station signals from the uplink transport data received by said by-pass physical analog RF donor interface, and provide the set of uplink base station signals to the foreign base station.

What is claimed is:

1. A radio access network (RAN) comprising:
a set of one or more physical server computers configured to execute virtualization software that creates a virtualized environment, wherein the set of physical server computers is configured to instantiate and execute a set of one or more virtual network functions (VNFs) used to implement at least one native base station and a virtual master unit (vMU) of a virtual distributed antenna system (vDAS), wherein the vDAS is configured to serve a foreign base station; and
a plurality of radio units (RUs), each of the RUs associated with a respective set of coverage antennas;
wherein the set of physical server computers is communicatively coupled to the plurality of RUs using a fronthaul network;
wherein the vDAS is configured to receive a set of downlink base station signals from a foreign base station and generate downlink base station data from the set of downlink base station signals;
wherein the vMU is configured to generate downlink transport data derived from the downlink base station data and communicate the downlink transport data to one or more of the RUs;
wherein each of said one or more of the RUs is configured to receive the downlink transport data, generate a set of downlink analog radio frequency (RF) signals from the downlink transport data, and wirelessly transmit the set of downlink analog RF signals from the respective set of coverage antennas associated with that RU;
wherein each of said one or more of the RUs is configured to receive a respective set of uplink analog RF signals via the respective set of coverage antennas associated with that RU, generate respective uplink transport data from the respective set of uplink analog RF signals, and communicate the uplink transport data over the fronthaul network;
wherein the vMU is configured to receive uplink transport data derived from the uplink transport communicated over the fronthaul network by each of said one or more of the RUs and generate uplink base station data from the uplink transport data received by the vMU; and
wherein the vDAS is configured to generate a set of uplink base station signals from the uplink base station data and provide the set of uplink base station signals to the foreign base station.

2. The RAN of claim 1, wherein the vMU is configured to generate the uplink base station data from the uplink transport data received by the vMU by combining user-plane data included in the uplink transport data received from by the vMU.

3. The vDAS of claim 1, wherein each of the set of physical server computers comprises at least one physical transport Ethernet interface; and
wherein the physical server computer used implement the vMU comprises at least one physical donor interface to couple the physical server computer to the foreign base station.

4. The RAN of claim 3, wherein the physical donor interface comprises a physical analog RF donor interface configured to:
receive the set of downlink base station signals from the foreign base station as a set of downlink analog RF signals and to generate the downlink base station data from the set of downlink base station signals by performing an analog-to-digital process on the downlink analog RF signals in order to generate the downlink base station data;
generate the set of uplink base station signals from the uplink base station data by performing by a digital-to-analog process on the uplink base station data in order to generate a set of uplink analog RF signals; and
provide the uplink analog RF signals to the foreign base station.

5. The RAN of claim 3, wherein the physical donor interface comprises a physical Common Public Radio Interface (CPRI) donor interface configured to:
receive the set of downlink base station signals from the foreign base station as a set of downlink CPRI signals;
generate the downlink base station data from the set of downlink CPRI signals;
generate the set of uplink base station signals from the uplink base station data as a set of uplink CPRI signals; and
provide the set of uplink CPRI signals to the foreign base station.

6. The RAN of claim 1, wherein the vDAS comprises a plurality of vMUs, each of the vMUs serving a different wireless service operator, each of the plurality of vMUs are communicatively coupled to a respective set of foreign base stations.

7. The RAN of claim 1, wherein the virtualization software is configured to dynamically instantiate VNFs to implement one or more vMUs.

8. The RAN of claim 1, wherein the vDAS is configured to serve multiple foreign base stations.

9. The RAN of claim 1, wherein the vDAS is configured to serve multiple base stations from multiple wireless service providers.

10. The RAN of claim 1, wherein the vDAS is configured to serve multiple base stations implementing multiple different radio access technologies, multiple base stations using multiple different RF bands or bandwidths, and/or multiple base stations implemented using different technology.

11. The RAN of claim 1, wherein the physical server computer used to implement the vMU is configured to time slice execution of at least some operations and/or processing performed by the vMU.

12. The RAN of claim 1, wherein the physical server computer used to implement the vMU is configured to time slice execution of at least one of: at least one input-output (IO) operation performed by the vMU and at least some baseband processing performed by the vMU.

13. The RAN of claim 1, wherein the vDAS further comprises an intermediate combining node (ICN); and
wherein at least one of said one or more of the RUs communicates the respective uplink transport data via the ICN.

14. The RAN of claim 13, wherein the ICN is implemented as one of: a physical network function using dedicated special-purpose hardware; and a virtual network function using a physical server.

15. The RAN of claim 1, wherein at least one of said one or more of the RUs communicates the respective uplink transport data via at least one other RU.

16. The RAN of claim 1, further comprising a by-pass physical analog RF donor interface configured to by-pass the vMU; and
wherein said by-pass physical analog RF donor interface is configured to:
receive, from the foreign base station, a set of downlink analog RF signals, generate downlink transport data, and communicate the downlink transport data to one or more RUs via the fronthaul network; and
receive uplink transport data derived from the uplink transport communicated over the fronthaul network by each of said one or more of the RUs, generate a set of uplink base station signals from the uplink transport data received by said by-pass physical analog RF donor interface, and provide the set of uplink base station signals to the foreign base station.

17. A method of providing wireless communication using a radio access network (RAN) comprising a set of one or more physical server computers configured to execute virtualization software that creates a virtualized environment, wherein the set of physical server computers is configured to instantiate and execute a set of one or more virtual network functions (VNFs) used to implement at least one native base station and a virtual master unit (vMU) of a virtual distributed antenna system (vDAS), the vDAS configured to serve a foreign base station, the RAN further comprising a plurality of radio units (RUs), each of the RUs associated with a respective set of coverage antennas, wherein the set of physical server computers is communicatively coupled to the plurality of RUs using a fronthaul network, the method comprising:
receiving a set of downlink base station signals from the foreign base station;
generating downlink base station data from the set of downlink base station signals; generating, by the vMU, downlink transport data derived from the downlink base station data;
communicating, by the vMU, the downlink transport data to one or more of the RUS;
receiving, by each of the one or more RUs, the downlink transport data;
generating a respective set of downlink analog radio frequency (RF) signals from the downlink transport data;
wirelessly transmitting the respective set of downlink analog RF signals from the respective set of coverage antennas associated with that RU;
wirelessly receiving, by each of said one or more of the RUs, a respective set of uplink analog RF signals via the respective set of coverage antennas associated with that RU;
generating, by each of said one or more of the RUs, respective uplink transport data from the respective set of uplink analog RF signals received by that RU;
communicating, by each of said one or more of the RUs, the respective uplink transport data over the fronthaul network;
receiving, by the vMU, uplink transport data derived from the respective uplink transport data communicated from each of said one or more of the RUs;
generating, by the vMU, uplink base station data from the uplink transport data received from all of said one or more of the RUs;
generating a set of uplink base station signals from the uplink base station data; and
providing the set of uplink base station signals to the foreign base station.

18. The method of claim 17, wherein generating the uplink base station data from the uplink transport data received by the vMU comprises combining user-plane data included in the uplink transport data received from by the vMU.

19. The method of claim 17, wherein each of the set of physical server computers comprises at least one physical transport Ethernet interface; and
wherein the physical server computer used implement the vMU comprises at least one physical donor interface to couple the physical server computer to the foreign base station.

20. The method of claim 19, wherein the physical donor interface comprises a physical analog RF donor interface configured to:
receive the set of downlink base station signals from the foreign base station as a set of downlink analog RF signals and to generate the downlink base station data from the set of downlink base station signals by performing an analog-to-digital process on the downlink analog RF signals in order to generate the downlink base station data;
generate the set of uplink base station signals from the uplink base station data by performing by a digital-to-analog process on the uplink base station data in order to generate a set of uplink analog RF signals; and
provide the uplink analog RF signals to the foreign base station.

21. The method of claim 19, wherein the physical donor interface comprises a physical Common Public Radio Interface (CPRI) donor interface configured to:
receive the set of downlink base station signals from the foreign base station as a set of downlink CPRI signals;
generate the downlink base station data from the set of downlink CPRI signals;
generate the set of uplink base station signals from the uplink base station data as a set of uplink CPRI signals; and
provide the set of uplink CPRI signals to the foreign base station.

22. The method of claim 17, wherein the vDAS comprises a plurality of vMUs, each of the vMUs serving a different wireless service operator, each of the plurality of vMUs are communicatively coupled to a respective set of foreign base stations.

23. The method of claim 17, wherein the virtualization software is configured to dynamically instantiate VNFs to implement one or more vMUs.

24. The method of claim 17, wherein the vDAS is configured to serve multiple foreign base stations.

25. The method of claim 17, wherein the vDAS is configured to serve multiple base stations from multiple wireless service providers.

26. The method of claim 17, wherein the vDAS is configured to serve multiple base stations implementing multiple different radio access technologies, multiple base stations using multiple different RF bands or bandwidths, and/or multiple base stations implemented using different technology.

27. The method of claim 17, wherein the physical server computer used to implement the vMU is configured to time slice execution of at least some operations and/or processing performed by the vMU.

28. The method of claim 17, wherein the physical server computer used to implement the vMU is configured to time slice execution of at least one of: at least one input-output (IO) operation performed by the vMU and at least some baseband processing performed by the vMU.

29. The method of claim 17, wherein the vDAS further comprises an intermediate combining node (ICN); and
wherein communicating, by each of said one or more of the RUs, the respective uplink transport data over the fronthaul network comprises communicating, by each of said one or more of the RUs, the respective uplink transport data via the ICN.

30. The method of claim 29, wherein the ICN is implemented as one of: a physical network function using dedicated special-purpose hardware; and a virtual network function using a physical server.

31. The method of claim 17, wherein communicating, by each of said one or more of the RUs, the respective uplink transport data over the fronthaul network comprises communicating, by at least one of said one or more of the RUs, the respective uplink transport data via at least one other RU.

32. The method of claim 17, wherein the vDAS further comprises a by-pass physical analog RF donor interface configured to by-pass the vMU; and
wherein said by-pass physical analog RF donor interface is configured to:
receive, from the foreign base station, a set of downlink analog RF signals, generate downlink transport data, and communicate the downlink transport data to one or more RUs via the fronthaul network; and
receive uplink transport data derived from the uplink transport communicated over the fronthaul network by each of said one or more of the RUs, generate a set of uplink base station signals from the uplink transport data received by said by-pass physical analog RF donor interface, and provide the set of uplink base station signals to the foreign base station.
